(19) United States
(12) Patent Application Publication
(10) Pub. No.: US 2021/0211703 A1
(43) Pub. Date: Jul. 8, 2021

(54) Geometry information signaling for occluded points in an occupancy map video

(71) Applicant: Apple Inc., Cupertino, CA (US)

(72) Inventors: Jungsun Kim, Sunnyvale, CA (US); Alexandros Tourapis, Los Gatos, CA (US); Khaled Mammou, Vancouver (CA)

(21) Appl. No.: 17/143,882

(22) Filed: Jan. 7, 2021

Related U.S. Application Data
(60) Provisional application No. 62/958,229, filed on Jan. 7, 2020.

(51) Int. Cl. H04N 19/46; G06T 7/50

(52) U.S. Cl. CPC H04N 19/46; G06T 2207/10028; G06T 7/50

(57) ABSTRACT

In an example method, points that represent three-dimensional visual volumetric content are received, and patches are determined, where each patch corresponds to a respective portion of the visual volumetric content. A patch image representing a set of points corresponding to the patch projected onto a respective patch plane is generated for each patch. The patch images are packed into image frames, and the image frames are encoded. An occupancy map corresponding to the image frames is generated. The occupancy map indicates, for each image frame: locations of the patch images in the image frame, and depth information of sets of points corresponding to the patch images in the image frame. The depth information indicates, for each patch image, depths of the set of points corresponding to the patch image in a direction perpendicular to a patch plane of the patch image.

### CROSS-REFERENCE TO RELATED APPLICATION

This application claims priority from U.S. Provisional Application Ser. No. 62/958,229, filed on Jan. 7, 2020, which is incorporated herein by reference in its entirety.

### TECHNICAL FIELD

This disclosure relates generally to compression and decompression of point clouds including a plurality of points, each having associated spatial information and attribute information.

### BACKGROUND

Various types of sensors, such as light detection and ranging (LIDAR) systems, 3-D-cameras, 3-D scanners, etc. may capture data indicating positions of points in three-dimensional space, for example positions in the X, Y, and Z planes. Also, such systems may further capture attribute information in addition to spatial information for the respective points, such as color information (e.g., RGB values), texture information, intensity attributes, reflectivity attributes, motion related attributes, modality attributes, or various other attributes. In some circumstances, additional attributes may be assigned to the respective points, such as a time-stamp when the point was captured. Points captured by such sensors may make up a “point cloud” including a set of points each having associated spatial information and one or more associated attributes. In some circumstances, a point cloud may include thousands of points, hundreds of thousands of points, millions of points, or even more points. Also, in some circumstances, point clouds may be generated, for example in software, as opposed to being captured by one or more sensors. In either case, such point clouds may include large amounts of data and may be costly and time-consuming to store and transmit.

### SUMMARY

In an aspect, a method includes receiving a plurality of points that represent three-dimensional visual volumetric content; determining, for the three-dimensional visual volumetric content, a plurality of patches, where each patch corresponds to a respective portion of the three-dimensional visual volumetric content; generating, for each patch, a patch image representing a set of points corresponding to the patch projected onto a respective patch plane; packing the patch images into one or more image frames; encoding the one or more image frames; and generating an occupancy map corresponding to the one or more image frames. The occupancy map indicates, for each image frame: locations of one or more of the patch images in the image frame, and depth information of one or more sets of points corresponding to the one or more of the patch images in the image frame. The depth information indicates, for each patch image, depths of the set of points corresponding to the patch image in a direction perpendicular to a patch plane of the patch image.

Implementations of this aspect can include one or more of the following features.

In some implementations, the occupancy map can include, for each patch image, a respective plurality of first elements. Each first element can correspond to a respective point on the patch plane of the patch image. Each first element can indicate respective depths of the points of the set of points corresponding to the patch image along a respective projection line, the projection line extending from the respective point on the patch plane in the direction perpendicular to the patch plane.

In some implementations, each first element can be determined based on a determination whether the set of points corresponding to the patch image includes any points along the respective projection line.

In some implementations, each first element can be determined based on the depth of each point of the set of points corresponding to the patch image along the respective projection line.

In some implementations, each first element can include a respective encoded value indicating the depth of each point of the set of points corresponding to the patch image along the respective projection line.

In some implementations, the encoded value can be determined based on a binary representation of the depths of at least some of the points of the set of points corresponding to the patch image along the respective projection line.

In some implementations, the method can further include down-sampling a spatial resolution of the occupancy map relative to a spatial resolution of the one or more image frames.

In some implementations, down-sampling the spatial resolution of the occupancy map can include determining a plurality of second elements based on the first elements, where each second element represents two or more respective first elements.

In some implementations, determining each second element can include identifying two or more respective first elements; comparing, with respect to the two or more respective first elements, the depths of the points of the set of points corresponding to the patch image along the respective projection lines, and determining the second element based on the comparison.

In some implementations, the comparison can include a bitwise binary operation.

In some implementations, the bitwise binary operation can include a bitwise OR operation or a bitwise AND operation.

In some implementations, each image frame can include a respective attribute image portion, where the attribute image portion is separated spatially from the patch images in the image frame, and where the attribute image portion indicates additional attribute information regarding at least one of the patch images in the image frame.

In some implementations, the attribute image portion can include a plurality of attribute image sub-portions, each attribute image sub-portion indicating respective additional attribute information regarding a respective patch image in the image frame.

In some implementations, each of the attribute image sub-portions can be equal in size spatially.

In some implementations, each attribute image sub-portion can include an indication of a location of the attribute image sub-portion in the image frame, and a spatial size of the attribute image sub-portion.

In some implementations, each attribute image sub-portion can include an indication of a patch image in the image frame corresponding to the attribute image sub-portion.

In some implementations, each attribute image sub-portion can include an indication of multiple patch images in the image frame corresponding to the attribute image sub-portion.

In some implementations, the one or more image frames can be encoded in accordance with the high efficiency video coding (HEVC) standard or some other image or video coding standard or specification.

In some implementations, each point can include spatial information regarding the point and attribute information regarding the point.

Other implementations are directed to systems, devices, and non-transitory, computer-readable media having instructions stored thereon, that when executed by one or more processors, cause the one or more processors to perform operations described herein.

The details of one or more embodiments are set forth in the accompanying drawings and the description below. Other features and advantages will be apparent from the description and drawings, and from the claims.

### BRIEF DESCRIPTION OF DRAWINGS

FIG. 1 illustrates a system including a sensor that captures information for points of a point cloud and an encoder that compresses spatial information and attribute information of the point cloud, where the compressed spatial and attribute information is sent to a decoder.

FIG. 2A illustrates components of an encoder for encoding intra point cloud frames.

FIG. 2B illustrates components of a decoder for decoding intra point cloud frames.

FIG. 3A illustrates an example patch segmentation process.

FIG. 3B illustrates an example image frame including packed patch images and padded portions.

FIG. 3C illustrates an example image frame including overlapping patches.

FIG. 3D illustrates a point cloud being projected onto multiple projections.

FIG. 3E illustrates a point cloud being projected onto multiple parallel projections.

FIG. 4 illustrates an example process of generating geometry and occupancy maps representing one or more points in a point cloud.

FIG. 5 illustrates another example process of generating geometry and occupancy maps representing one or more points in a point cloud.

FIG. 6 illustrates example schemes for down-sampling an occupancy map.

FIG. 7 illustrates additional example schemes for down-sampling an occupancy map when the occupancy map has the depth information.

FIG. 8A illustrates an example scheme for a threshold based non-binary occupancy map.

FIG. 8B illustrates an example segmentation of an occupancy range.

FIG. 9 illustrates an example scheme for generating a multi-threshold non-binary occupancy map.

FIG. 10 shows an image frame including an example occupancy map, and an image frame including a corresponding attribute map.

FIG. 11 illustrates an example process for generating information regarding a point cloud.

FIG. 12 illustrates an example process for using compressed point cloud information in a 3-D telepresence application.

FIG. 13 illustrates an example process for using compressed point cloud information in a virtual reality application.

FIG. 14 illustrates an example computer system that may implement an encoder or decoder.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f), for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

As data acquisition and display technologies have become more advanced, the ability to capture point clouds including thousands or millions of points in 2-D or 3-D space, such as via LIDAR systems, has increased. Also, the development of advanced display technologies, such as virtual reality or augmented reality systems, has increased potential uses for point clouds. However, point cloud files are often very large and may be costly and time-consuming to store and transmit. For example, communication of point clouds over private or public networks, such as the Internet, may require considerable amounts of time and/or network resources, such that some uses of point cloud data, such as real-time uses, may be limited. Also, storage requirements of point cloud files may consume a significant amount of storage capacity of devices storing the point cloud files, which may also limit potential applications for using point cloud data.

In some embodiments, an encoder may be used to generate a compressed point cloud to reduce costs and time associated with storing and transmitting large point cloud files. In some embodiments, a system may include an encoder that compresses attribute and/or spatial information of a point cloud file such that the point cloud file may be stored and transmitted more quickly than non-compressed point clouds and in a manner that the point cloud file may occupy less storage space than non-compressed point clouds.

In some embodiments, compression of attributes of points in a point cloud may enable a point cloud to be communicated over a network in real-time or in near real-time. For example, a system may include a sensor that captures attribute information about points in an environment where the sensor is located, where the captured points and corresponding attributes make up a point cloud. The system may also include an encoder that compresses the captured point cloud attribute information. The compressed attribute information of the point cloud may be sent over a network in real-time or near real-time to a decoder that decompresses the compressed attribute information of the point cloud. The decompressed point cloud may be further processed, for example to make a control decision based on the surrounding environment at the location of the sensor. The control decision may then be communicated back to a device at or near the location of the sensor, where the device receiving the control decision implements the control decision in real-time or near real-time. In some embodiments, the decoder may be associated with an augmented reality system and the decompressed attribute information may be displayed or otherwise used by the augmented reality system. In some embodiments, compressed attribute information for a point cloud may be sent with compressed spatial information for points of the point cloud. In other embodiments, spatial information and attribute information may be separately encoded and/or separately transmitted to a decoder.

In some embodiments, a system may include a decoder that receives one or more sets of point cloud data including compressed attribute information via a network from a remote server or other storage device that stores the one or more point cloud files. For example, a 3-D display, a holographic display, or a head-mounted display may be manipulated in real-time or near real-time to show different portions of a virtual world represented by point clouds. In order to update the 3-D display, the holographic display, or the head-mounted display, a system associated with the decoder may request point cloud data from the remote server based on user manipulations of the displays, and the point cloud data may be transmitted from the remote server to the decoder and decoded by the decoder in real-time or near real-time. The displays may then be updated with updated point cloud data responsive to the user manipulations, such as updated point attributes.

In some embodiments, a system, may include one or more LIDAR systems, 3-D cameras, 3-D scanners, etc., and such sensor devices may capture spatial information, such as X, Y, and Z coordinates for points in a view of the sensor devices. In some embodiments, the spatial information may be relative to a local coordinate system or may be relative to a global coordinate system (e.g., a Cartesian coordinate system may have a fixed reference point, such as a fixed point on the earth, or may have a non-fixed local reference point, such as a sensor location).

In some embodiments, such sensors may also capture attribute information for one or more points, such as color attributes, reflectivity attributes, velocity attributes, acceleration attributes, time attributes, modalities, and/or various other attributes. In some embodiments, other sensors, in addition to LIDAR systems, 3-D cameras, 3-D scanners, etc., may capture attribute information to be included in a point cloud. For example, in some embodiments, a gyroscope or accelerometer, may capture motion information to be included in a point cloud as an attribute associated with one or more points of the point cloud. For example, a vehicle equipped with a LIDAR system, a 3-D camera, or a 3-D scanner may include the vehicle's direction and speed in a point cloud captured by the LIDAR system, the 3-D camera, or the 3-D scanner. For example, when points in a view of the vehicle are captured they may be included in a point cloud, where the point cloud includes the captured points and associated motion information corresponding to a state of the vehicle when the points were captured.

In some embodiments, the one or more patch images can include attribute and/or spatial information of the point cloud projected onto the patch image using one or more projections. For example, projections may include cylindrical or spherical projections, where the point cloud is projected onto a cylinder or sphere. Also, in some embodiments, multiple parallel projections of the point cloud may be used to generate patch images for the point cloud, where the multiple projections are known by or signaled to a decoder. In some implementations, one or more patch images can be packed in to one or more image frames of a video. The image frames can be encoded according to a video encoding standard, such as the high efficiency video coding (HEVC) standard or some other image or video coding standard or specification (e.g., VP9, VP10, or some other standard or specification).

In some embodiments, attribute and/or spatial information for a point cloud can be compressed by projecting the point cloud onto multiple projections and encoding the projections (e.g., in one or more layers of a patch image). For example, projections may include cylindrical or spherical projections, where the point cloud is projected onto a cylinder or sphere. Also, in some embodiments, multiple parallel projections of the point cloud may be encoded, where the multiple projections are known by or signaled to a decoder.

In some embodiments, points of a point cloud may be in a same or nearly same location when projected onto a patch plane. For example, the point cloud might have a depth such that some points are in the same location relative to the patch plane, but at different depths. An occupancy map having one or more layers can be generated to provide information regarding one or more of these points. For example, an occupancy map can indicate, for each image frame, the locations of one or more patch images packed into the image frame, and depth information of one or more sets of points corresponding to the patch images in the image frame. Further, the depth information can indicate, for each patch image, depths of the set of points corresponding to the patch image (e.g., with respect to a projection direction perpendicular to the patch plane of the patch image).

### Example System Arrangement

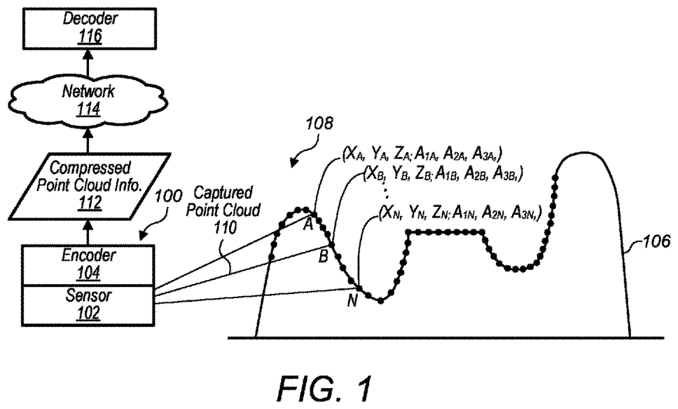

FIG. 1 illustrates a system including a sensor that captures information for points of a point cloud and an encoder that compresses attribute information of the point cloud, where the compressed attribute information is sent to a decoder.

System 100 includes sensor 102 and encoder 104. Sensor 102 captures a point cloud 110 including points representing structure 106 in view 108 of sensor 102. For example, in some embodiments, structure 106 may be a mountain range, a building, a sign, an environment surrounding a street, or any other type of structure. In some embodiments, a captured point cloud, such as captured point cloud 110, may include spatial and attribute information for the points included in the point cloud. For instance, in the example shown in FIG. 1, point A of captured point cloud 110 includes X, Y, Z coordinates and attributes 1, 2, and 3. In some embodiments, attributes of a point may include attributes such as R, G, B color values, a velocity at the point, an acceleration at the point, a reflectance of the structure at the point, a time stamp indicating when the point was captured, a string-value indicating a modality when the point was captured, for example “walking,” or other attributes. The captured point cloud 110 may be provided to encoder 104, where encoder 104 generates a compressed version of the point cloud (e.g., compressed attribute information 112) that is transmitted via network 114 to decoder 116. In some embodiments, a compressed version of the point cloud, such as compressed attribute information 112, may be included in a common compressed point cloud that also includes compressed spatial information for the points of the point cloud or, in some embodiments, compressed spatial information and compressed attribute information may be communicated as separate sets of data.

In some embodiments, encoder 104 may be integrated with sensor 102. For example, encoder 104 may be implemented in hardware or software included in a sensor device, such as sensor 102. In other embodiments, encoder 104 may be implemented on a separate computing device that is proximate to sensor 102.

### Example Intra-Frame Encoder

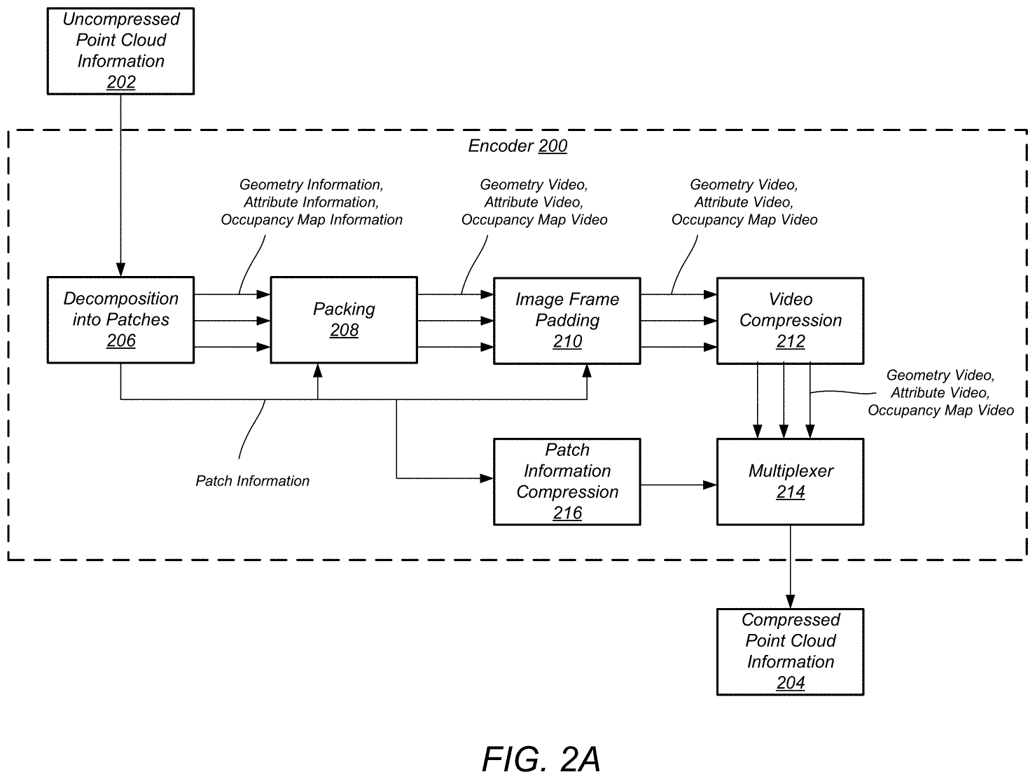

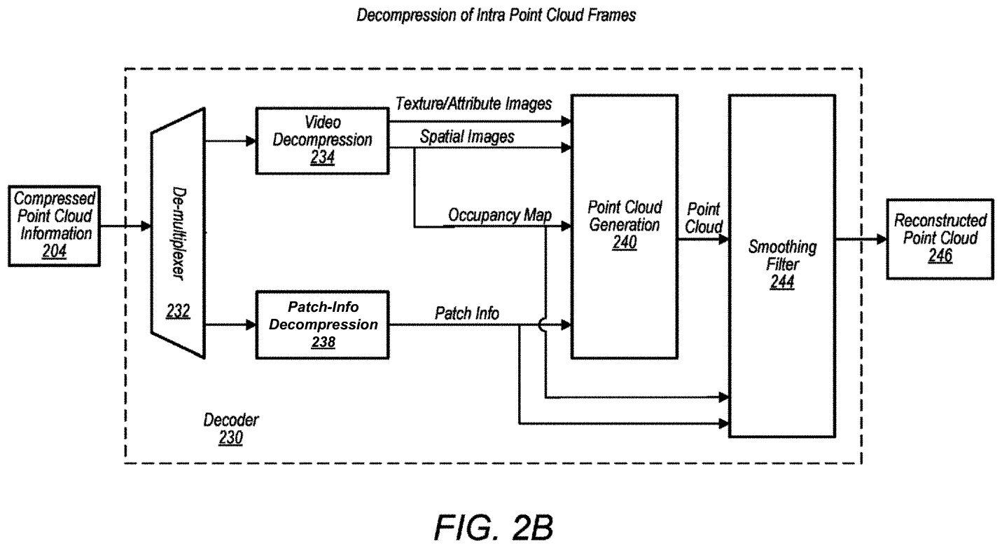

FIG. 2A illustrates components of an encoder for encoding intra point cloud frames. In some embodiments, the encoder described above in regard to FIG. 1 may operate in a similar manner as encoder 200 described in FIG. 2A.

The encoder 200 receives uncompressed point cloud 202 and generates compressed point cloud information 204. In some embodiments, an encoder, such as encoder 200, may receive the uncompressed point cloud 202 from a sensor, such as sensor 102 illustrated in FIG. 1, or, in some embodiments, may receive the uncompressed point cloud 202 from another source, such as a graphics generation component that generates the uncompressed point cloud in software, as an example.

In some embodiments, an encoder, such as encoder 200, includes decomposition into patches module 206, packing module 208, an image frame padding module 210, video compression module 212, and multiplexer 214. In addition, an encoder can include a patch information compression module, such as patch information compression module 216.

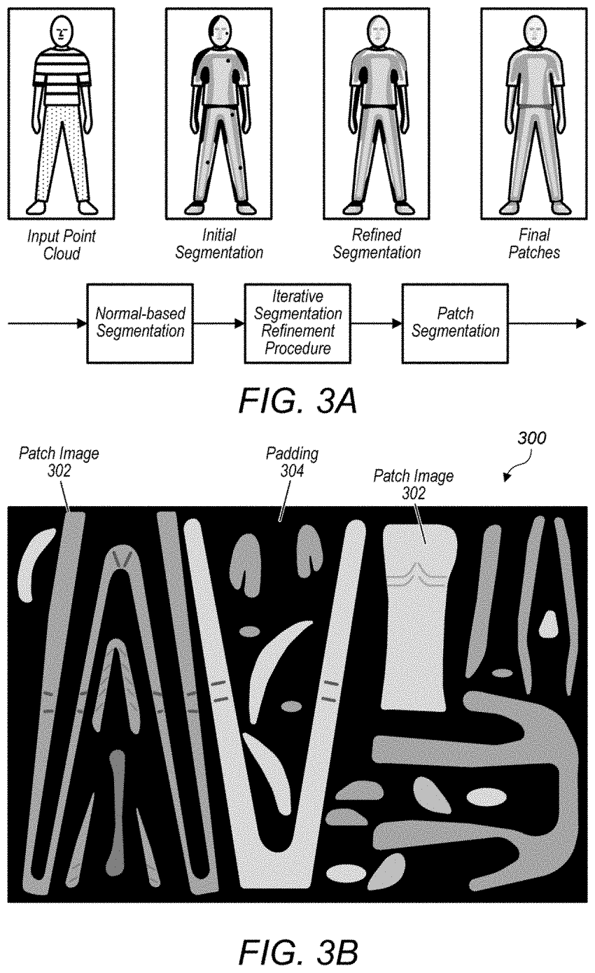

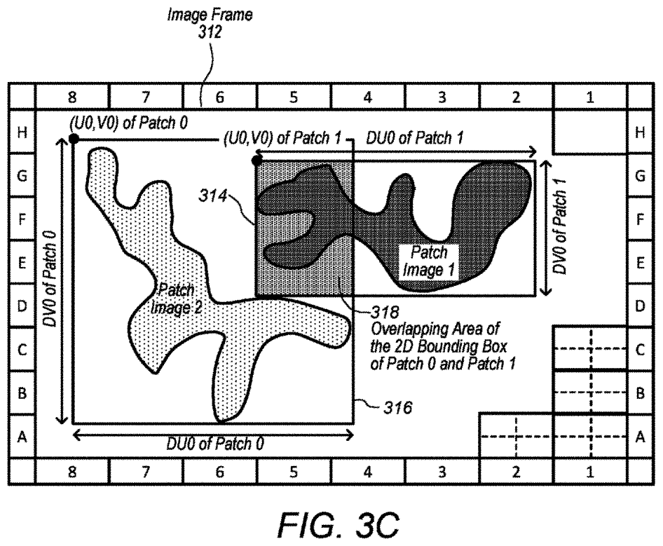

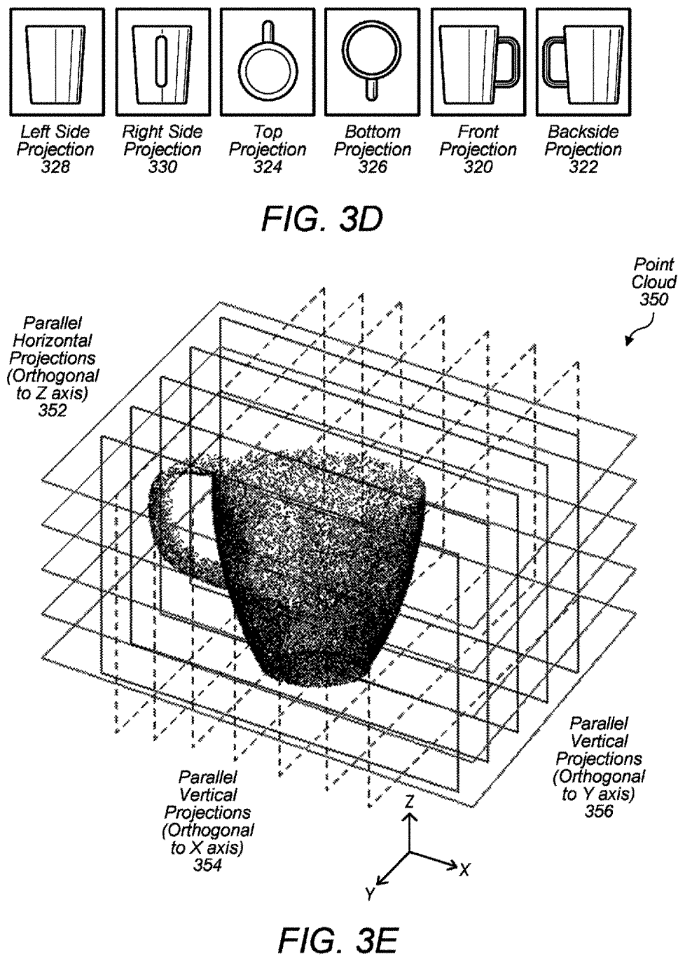

In some embodiments, the conversion process decomposes the point cloud into a set of patches (e.g., a patch is defined as a contiguous subset of the surface described by the point cloud), which may be overlapping or not, such that each patch may be described by a depth field with respect to a plane in 2D space. More details about the patch decomposition process are provided above with regard to FIGS. 3A-3C. Further, the encoder can produce one or more of geometry information, attribute information, and/or occupancy map information regarding the point cloud.

After or in conjunction with the patches being determined for the point cloud being compressed, a 2D sampling process is performed in planes associated with the patches. The 2D sampling process may be applied in order to approximate each patch with a uniformly sampled point cloud, which may be stored as a set of 2D patch images describing the occupancy map, geometry, and/or attributes of the point cloud at the patch location. The “packing” module 208 may store the 2D patch images associated with the patches in a single (or multiple) 2D images, referred to herein as “image frames.” In some embodiments, a packing module, such as packing module 208, may pack the 2D patch images such that the packed 2D patch images do not overlap (even though an outer bounding box for one patch image may overlap an outer bounding box for another patch image). Also, the packing module 208 may pack the 2D patch images in a way that minimizes non-used images pixels of the image frame. In some implementations, patch information can be used to convert the projected images into a point cloud by indicating sizes and shapes of the patches, the locations of the patches, and/or other information regarding the patches. This information can be encoded by a patch-information compression module, such as patch information compression module 216.

In some embodiments, 2D patch images associated with the occupancy map, geometry, and/or attributes of a point cloud can be generated at a given patch location. As noted before, a packing process, such as performed by packing module 208, may leave some empty spaces between 2D patch images packed in an image frame. Also, a padding module, such as image frame padding module 210, may fill in such areas in order to generate an image frame that may be suited for 2D video and image codecs.

In some embodiments, an occupancy map (e.g., information describing for each pixel or block of pixels whether the pixel or block of pixels are padded or not, and depth information for one or more points associated with that pixel or block of pixels) may be generated and compressed. The occupancy map may be sent to a decoder to enable the decoder to distinguish between padded and non-padded pixels of an image frame, and to determining the depth of one or more points associated with the padded pixels of the image frame.

In some embodiments one or more image frames may be encoded by a video encoder, such as video compression module 212. In some embodiments, a video encoder, such as video compression module 212, may operate in accordance with the High Efficiency Video Coding (HEVC) standard or other suitable video encoding standard or specification (e.g., VP9, VP10, or some other standard or specification). In some embodiments, encoded video images, encoded occupancy map information, and encoded patch information may be multiplexed by a multiplexer, such as multiplexer 214, and provided to a recipient as compressed point cloud information, such as compressed point cloud information 204.

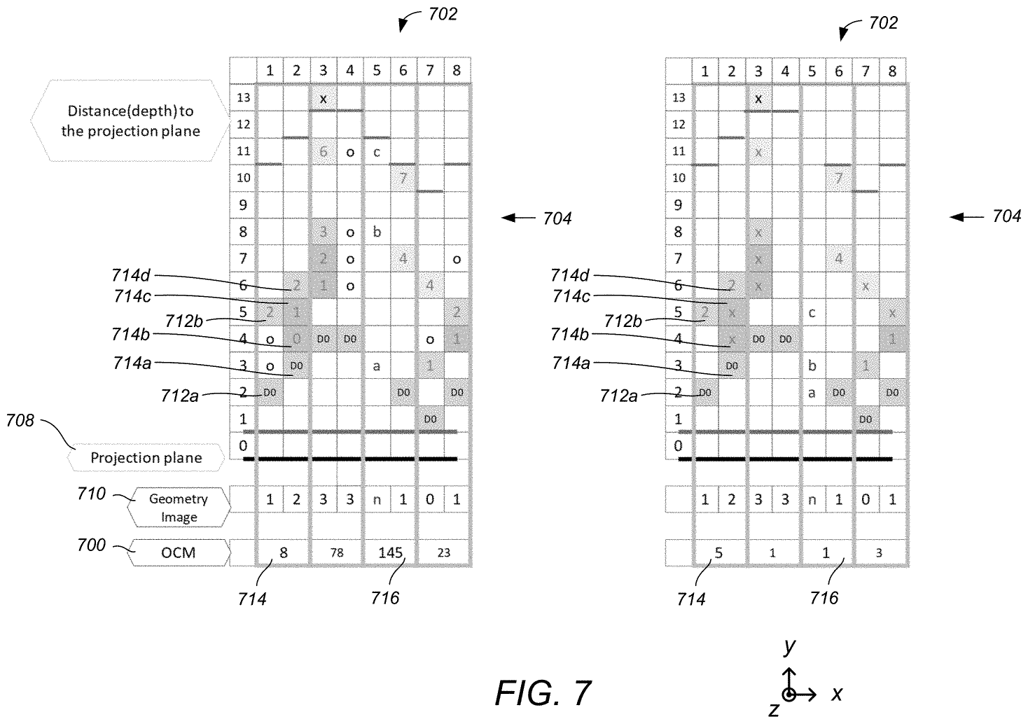

In some embodiments, an occupancy map may be encoded and decoded by a video compression module, such as video compression module 212. This may be done at an encoder, such as encoder 200, such that the encoder has an accurate representation of what the occupancy map will look like when decoded by a decoder. Also, variations in image frames due to lossy compression and decompression may be accounted for when determining an occupancy map for an image frame. In some embodiments, various techniques may be used to further compress an occupancy map, such as described in FIGS. 7-11.

### Example Intra-Frame Decoder

FIG. 2B illustrates components of a decoder for decoding intra point cloud frames. Decoder 230 receives compressed point cloud information 204, which may be the same compressed point cloud information 204 generated by encoder 200. Decoder 230 generates reconstructed point cloud 246 based on receiving the compressed point cloud information 204.

In some embodiments, a decoder, such as decoder 230, includes a de-multiplexer 232, a video decompression module 234, and an patch-information decompression module 238. Additionally a decoder, such as decoder 230 includes a point cloud generation module 240, which reconstructs a point cloud based on patch images included in one or more image frames included in the received compressed point cloud information, such as compressed point cloud information 204. In some embodiments, a decoder, such as decoder 230, further includes a smoothing filter, such as smoothing filter 244. In some embodiments, a smoothing filter may smooth incongruences at edges of patches, where data included in patch images for the patches has been used by the point cloud generation module to recreate a point cloud from the patch images for the patches. In some embodiments, a smoothing filter may be applied to the pixels located on the patch boundaries to alleviate the distortions that may be caused by the compression/decompression process.

### Segmentation Process

FIG. 3A illustrates an example segmentation process for determining patches for a point cloud. The segmentation process as described in FIG. 3A may be performed by a decomposition into patches module, such as decomposition into patches module 206. A segmentation process may decompose a point cloud into a minimum number of patches (e.g., a contiguous subset of the surface described by the point cloud), while making sure that the respective patches may be represented by a depth field with respect to a patch plane. This may be done without a significant loss of shape information.

In some embodiments, a segmentation process may include:
Letting point cloud PC be the input point cloud to be partitioned into patches and {P(0), P(1) . . . , P(N−1)} be the positions of points of point cloud PC.
In some embodiments, a fixed set D={D(0), D(1), . . . , D (K−1)} of K 3D orientations is pre-defined. For instance, D may be chosen as follows D={(1.0, 0.0, 0.0), (0.0, 1.0, 0.0), (0.0, 0.0, 1.0), (−1.0, 0.0, 0.0), (0.0, −1.0, 0.0), (0.0, 0.0, −1.0)}.
In some embodiments, the normal vector to the surface at every point P(i) is estimated. Any suitable algorithm may be used to determine the normal vector to the surface. For instance, a technique could include fetching the set H of the N nearest points of P(i), and fitting a plane Π(i) to H(i) by using principal component analysis techniques. The normal to P(i) may be estimated by taking the normal V(i) to Π(i). Note that N may be a user-defined parameter or may be found by applying an optimization procedure. N may also be fixed or adaptive. The normal values may then be oriented consistently by using a minimum-spanning tree approach.
Normal-based Segmentation: An initial segmentation S0 of the points of point cloud PC may be obtained by associating respective points with the direction D(k) which maximizes the score (∀(i)|D(k)), where (.|.) is the canonical dot product of R3. Pseudo code is provided below:

TABLE 1
Pseudo code for normal-based segmentation.

for (i = O; i < pointCount; ++i) {

clusterlndex = 0;
bestScore = <∇(i)|D(0)>;
for(j = 1; j < K; ++j) {

score= <∇(i)|D(j)>;
if (score> bestScore) {

bestScore = score;
clusterlndex = j;

}

}
partition[i] = clusterIndex;

}

Iterative segmentation refinement: Note that segmentation S0 associates respective points with the plane Π(i) that best preserves the geometry of its neighborhood (e.g., the neighborhood of the segment). In some circumstances, segmentation S0 may generate too many small connected components with irregular boundaries, which may result in poor compression performance. In order to avoid such issues, the following iterative segmentation refinement procedure may be applied:
   1. An adjacency graph A may be built by associating a vertex V(i) to respective points P(i) of point cloud PC and by adding R edges {E(i,j(0)), . . . , E(i, j(R−1)} connecting vertex V(i) to its nearest neighbors {V(j(0)), V(j(1)), . . . , V(j(R−1))}. More precisely, {V(j(0)), V(j(1)), . . . , V(j(R−1))} may be the vertices associated with the points {P(j(0)), P(j(1)), . . . , P(j(R−1))}, which may be the nearest neighbors of P(i). Note that R may be a user-defined parameter or may be found by applying an optimization procedure. It may also be fixed or adaptive.
   2. At each iteration, the points of point cloud PC may be traversed and every vertex may be associated with the direction D(k) that maximizes

$$( 〈 ∇ ( i ) \text{\textbar} D ( k ) 〉 + \frac{λ}{R} \vert ζ ( i ) \vert ) ,$$

where ζ(i) is the number of the R-nearest neighbors of V(i) belonging to the same cluster and λ is a parameter controlling the regularity of the produced patches. Note that the parameters λ and R may be defined by the user or may be determined by applying an optimization procedure. They may also be fixed or adaptive. In some embodiments, a “user” as referred to herein may be an engineer who configured a point cloud compression technique as described herein to one or more applications. ϵ
3. An example of pseudo code is provided below:

TABLE 2
Pseudo code for iterative segmentation refinement.

for(I = 0; I< iterationCount; ++I) {

for(i = O; i < pointCount; ++i) {

clusterlndex = partition[i];
bestScore = 0.0;
for(k = 0; k < K; ++k) {

score= [symbol] ∇(i)|D(k) [symbol] ;
for(j ∈ {j(0),j(1), ... ,j(R−1)}) {

if (k == partition[j]) {

score += λ / R′ ;

}

}
if (score> bestScore) {

bestScore = score;
clusterlndex = k;

}

}
partition[i] = clusterIndex;

In some embodiments, the pseudo code shown above may further include an early termination step. For example, if a score that is a particular value is reached, or if a difference between a score that is reached and a best score only changes by a certain amount or less, the search could be terminated early. Also, the search could be terminated if after a certain number of iterations (l=m), the clusterindex does not change.
Patch segmentation: In some embodiments, the patch segmentation procedure further segments the clusters detected in the previous steps into patches, which may be represented with a depth field with respect to a projection plane. The approach proceeds as follows, according to some embodiments:
   1. First, a cluster-based adjacency graph with a number of neighbors R′ is built, while considering as neighbors only the points that belong to the same cluster. Note that R′ may be different from the number of neighbors R used in the previous steps.
   2. Next, the different connected components of the cluster-based adjacency graph are extracted. Only connected components with a number of points higher than a parameter a are considered. Let CC={CC(0), CC(1), . . . , CC(M−1)} be the set of the extracted connected components.
   3. Respective connected component CC(m) inherits the orientation D(m) of the cluster it belongs to. The points of CC(m) are then projected on a projection plane having as normal the orientation D(m), while updating a depth map, which records for every pixel the depth of the nearest point to the projection plane.
   4. An approximated version of CC(m), denoted C′(m), is then built by associating respective updated pixels of the depth map with a 3D point having the same depth. Let PC be the point cloud obtained by the union of reconstructed connected components {CC′(0), CC′(1), . . . , CC′(M−1)}.
   5. Note that the projection reconstruction process may be lossy and some points may be missing. In order, to detect such points, every point P(i) of point cloud PC may be checked to make sure it is within a distance lower than a parameter δ from a point of PC. If this is not the case, then P(i) may be marked as a missed point and added to a set of missed points denoted MP.
   6. The steps 2-5 are then applied to the missed points MP. The process is repeated until MP is empty or CC is empty. Note that the parameters δ and a may be defined by the user or may be determined by applying an optimization procedure. They may also be fixed or adaptive.
   7. A filtering procedure may be applied to the detected patches in order to make them better suited for compression. Example filter procedures may include:
      a. A smoothing filter based on the geometry/texture/attributes of the points of the patches (e.g., median filtering), which takes into account both spatial and temporal aspects.
      b. Discarding small and isolated patches.
      c. User-guided filtering.
      d. Other suitable smoothing filter techniques.

### Layers

The image generation process described above includes projecting the points belonging to each patch onto its associated projection plane to generate a patch image. This process could be generalized to handle the situation where multiple points are projected onto the same pixel as follows:
Let H(u, v) be the set of points of the current patch that get projected to the same pixel (u, v). Note that H(u, v) may be empty, may have one point or multiple points.
If H(u, v) is empty then the pixel is marked as unoccupied.
If the H(u, v) has a single element, then the pixel is filled with the associated geometry/texture/attribute value.
If H(u, v), has multiple elements, then different strategies are possible:
   Keep only the nearest point P0(u, v) for the pixel (u, v)
   Take the average or a linear combination of a group of points that are within a distance d from P0(u, v), where d is a user-defined parameter needed only on the encoder side.
   Store two images: one for P0(u, v) and one to store the farthest point Pl(u, v) of H(u, v) that is within a distance d from P0(u, v)
   Store N patch images containing a subset of H(u, v)

The generated patch images for point clouds with points at the same patch location, but different depths may be referred to as layers herein. In some embodiments, scaling/up-sampling/down-sampling could be applied to the produced patch images/layers in order to control the number of points in the reconstructed point cloud.

Guided up-sampling strategies may be performed on the layers that were down-sampled given the full resolution image from another “primary” layer that was not down-sampled.

Down-sampling could leverage the closed loop techniques as described below in regard to closed-loop color conversion, while exploiting a guided up-sampling strategy. For example, a generated layer may be encoded independently, which allows for parallel decoding and error resilience. Also encoding strategies, such as those specified by the scalable-HEVC standard, may be leveraged in order to support advanced functionalities such as spatial, SNR (signal to noise ratio), and color gamut scalability.

In some embodiments, a delta prediction between layers could be adaptively applied based on a rate-distortion optimization. This choice may be explicitly signaled in the bit stream.

In some embodiments, the generated layers may be encoded with different precisions. The precision of each layer may be adaptively controlled by using a shift+scale or a more general linear or non-linear transformation.

In some embodiments, an encoder may make decisions on a scaling strategy and parameters, which are explicitly encoded in the bit stream. The decoder may read the information from the bit stream and apply the right scaling process with the parameters signaled by the encoder.

In some embodiments, a video encoding motion estimation process may be guided by providing a motion vector map to the video encoder indicating for each block of the image frame, a 2D search center or motion vector candidates for the refinement search. Such information, may be trivial to compute since the mapping between the 3D frames and the 2D image frames is available to the point cloud encoder and a coarse mapping between the 2D image frames could be computed by using a nearest neighbor search in 3D.

The video motion estimation/mode decision/intra-prediction could be accelerated/improved by providing a search center map, which may provide guidance on where to search and which modes to choose from for each N×N pixel block.

Hidden/non-displayed pictures could be used in codecs such as AV1 and HEVC. In particular, synthesized patches could be created and encoded (but not displayed) in order to improve prediction efficiency. This could be achieved by re-using a subset of the padded pixels to store synthesized patches.

The patch re-sampling (e.g., packing and patch segmentation) process described above exploits solely the geometry information. A more comprehensive approach may take into account the distortions in terms of geometry, texture, and other attributes and may improve the quality of the re-sampled point clouds.

Instead of first deriving the geometry image and optimizing the texture image given said geometry, a joint optimization of geometry and texture could be performed. For example, the geometry patches could be selected in a manner that results in minimum distortion for both geometry and texture. This could be done by immediately associating each possible geometry patch with its corresponding texture patch and computing their corresponding distortion information. Rate-distortion optimization could also be considered if the target compression ratio is known.

In some embodiments, a point cloud resampling process described above may additionally consider texture and attributes information, instead of relying only on geometry.

Also, a projection-based transformation that maps 3D points to 2D pixels could be generalized to support arbitrary 3D to 2D mapping as follows:
Store the 3D to 2D transform parameters or the pixel coordinates associated with each point
Store X, Y, Z coordinates in the geometry images instead of or in addition to the depth information

### Packing

In some embodiments, depth maps associated with patches, also referred to herein as “depth patch images,” such as those described above, may be packed into a 2D image frame. For example, a packing module, such as packing module 208, may pack depth patch images generated by a spatial image generation module. The depth maps, or depth patch images, may be packed such that (A) no non-overlapping block of T×T pixels contains depth information from two different patches and such that (B) a size of the generated image frame is minimized.

In some embodiments, packing includes the following steps:
a. The patches are sorted by height and then by width. The patches are then inserted in image frame (I) one after the other in that order. At each step, the pixels of image frame (I) are traversed in raster order, while checking if the current patch could be inserted under the two conditions (A) and (B) described above. If it is not possible then the height of (I) is doubled.
b. This process is iterated until all the patches are inserted.

In some embodiments, the packing process described above may be applied to pack a subset of the patches inside multiples tiles of an image frame or multiple image frames. This may allow patches with similar/close orientations based on visibility according to the rendering camera position to be stored in the same image frame/tile, to enable view-dependent streaming and/or decoding. This may also allow parallel encoding/decoding.

In some embodiments, the packing process can be considered a bin-packing problem and a first decreasing strategy as described above may be applied to solve the bin-packing problem. In other embodiments, other methods such as the modified first fit decreasing (MFFD) strategy may be applied in the packing process.

In some embodiments, if temporal prediction is used, such as described for inter compression encoder 250, such an optimization may be performed with temporal prediction/encoding in addition to spatial prediction/encoding. Such consideration may be made for the entire video sequence or per group of pictures (GOP). In the latter case additional constraints may be specified. For example, a constraint may be that the resolution of the image frames should not exceed a threshold amount. In some embodiments, additional temporal constraints may be imposed, even if temporal prediction is not used, for example such as that a patch corresponding to a particular object view is not moved more than x number of pixels from previous instantiations.

FIG. 3B illustrates an example image frame including packed patch images and padded portions. Image frame 300 includes patch images 302 packed into image frame 300 and also includes padding 304 in space of image frame 300 not occupied by patch images. In some embodiments, padding, such as padding 304, may be determined so as to minimize incongruences between a patch image and the padding. For example, in some embodiments, padding may construct new pixel blocks that are replicas of, or are to some degree similar to, pixel blocks that are on the edges of patch images. Because an image and/or video encoder may encode based on differences between adjacent pixels, such an approach may reduce the number of bytes required to encode an image frame including patch images and padding.

In some embodiments, the patch information may be stored in the same order as the order used during the packing, which makes it possible to handle overlapping 2D bounding boxes of patches. Thus, a decoder receiving the patch information can extract patch images from the image frame in the same order in which the patch images were packed into the image frame. Also, because the order is known by the decoder, the decoder can resolve patch image bounding boxes that overlap.

FIG. 3C illustrates an example image frame 312 with overlapping patches, according to some embodiments. FIG. 3C shows an example with two patches (patch image 1 and patch image 2) having overlapping 2D bounding boxes 314 and 316 that overlap at area 318. In order to determine to which patch the T×T blocks in the area 318 belong, the order of the patches may be considered. For example, the T×T block 314 may belong to the last decoded patch. This may be because in the case of an overlapping patch, a later placed patch is placed such that it overlaps with a previously placed patch. By knowing the placement order it can be resolved that areas of overlapping bounding boxes go with the latest placed patch. In some embodiments, the patch information is predicted and encoded (e.g., with an entropy/arithmetic encoder). Also, in some embodiments, U0, V0, DUO and DV0 are encoded as multiples of T, where T is the block size used during the padding phase.

FIG. 3C also illustrates blocks of an image frame 312, where the blocks may be further divided into sub-blocks. For example block A1, B1, C1, A2, etc. may be divided into multiple sub-blocks, and, in some embodiments, the sub-blocks may be further divided into smaller blocks. In some embodiments, a video compression module of an encoder, such as video compression module 212 or video compression module 264, may determine whether a block includes active pixels, non-active pixels, or a mix of active and non-active pixels. The video compression module may budget fewer resources to compress blocks including non-active pixels than an amount of resources that are budgeted for encoding blocks including active pixels. In some embodiments, active pixels may be pixels that include data for a patch image and non-active pixels may be pixels that include padding. In some embodiments, a video compression module may sub-divide blocks including both active and non-active pixels, and budget resources based on whether sub-blocks of the blocks include active or non-active pixels. For example, blocks A1, B1, C1, A2 may include non-active pixels. As another example block E3 may include active pixels, and block B6, as an example, may include a mix of active and non-active pixels.

In some embodiments, a patch image may be determined based on projections, such as projecting a point cloud onto a cube, cylinder, sphere, etc. In some embodiments, a patch image may include a projection that occupies a full image frame without padding. For example, in a cubic projection each of the six cubic faces may be a patch image that occupies a full image frame.

For example, FIG. 3D illustrates a point cloud being projected onto multiple projections.

In some embodiments, a representation of a point cloud is encoded using multiple projections. For example, instead of determining patches for a segment of the point cloud projected on a plane perpendicular to a normal to the segment, the point cloud may be projected onto multiple arbitrary planes or surfaces. For example, a point cloud may be projected onto the sides of a cube, cylinder, sphere, etc. Also multiple projections intersecting a point cloud may be used. In some embodiments, the projections may be encoded using conventional video compression methods, such as via a video compression module 212 or video compression module 264. In particular, the point cloud representation may be first projected onto a shape, such as a cube, and the different projections/faces projected onto that shape (i.e., front (320), back (322), top (324), bottom (326), left (328), right (330)) may all be packed onto a single image frame or multiple image frames. This information, as well as depth information may be encoded separately or with coding tools such as the ones provided in the 3D extension of the HEVC (3D-HEVC) standard. The information may provide a representation of the point cloud since the projection images can provide the (x,y) geometry coordinates of all projected points of the point cloud. Additionally, depth information that provides the z coordinates may be encoded. In some embodiments, the depth information may be determined by comparing different ones of the projections, slicing through the point cloud at different depths. When projecting a point cloud onto a cube, the projections might not cover all point cloud points, e.g., due to occlusions. Therefore, additional information may be encoded to provide for these missing points and updates may be provided for the missing points.

In some embodiments, adjustments to a cubic projection can be performed that further improve upon such projections. For example, adjustments may be applied at the encoder only (non-normative) or applied to both the encoder and the decoder (normative).

More specifically, in some embodiments alternative projections may be used. For example, instead of using a cubic projection, a cylindrical or spherical type of a projection method may be used. Such methods may reduce, if not eliminate, redundancies that may exist in the cubic projection and reduce the number or the effect of “seams” that may exist in cubic projections. Such seams may create artifacts at object boundaries, for example. Eliminating or reducing the number or effect of such seams may result in improved compression/subjective quality as compared to cubic projection methods. For a spherical projection case, a variety of sub-projections may be used, such as the equirectangular, equiangular, and authagraph projection among others. These projections may permit the projection of a sphere onto a 2D plane. In some embodiments, the effects of seams may be de-emphasized by overlapping projections, where multiple projections are made of a point cloud, and the projections overlap with one another at the edges, such that there is overlapping information at the seams. A blending effect could be employed at the overlapping seams to reduce the effects of the seams, thus making them less visible.

In addition to, or instead of, considering a different projection method (such as cylindrical or spherical projections), in some embodiments multiple parallel projections may be used. The multiple parallel projections may provide additional information and may reduce a number of occluded points. The projections may be known at the decoder or signaled to the decoder. Such projections may be defined on planes or surfaces that are at different distances from a point cloud object. Also, in some embodiments the projections may be of different shapes, and may also overlap or cross through the point cloud object itself. These projections may permit capturing some characteristics of a point cloud object that may have been occluded through a single projection method or a patch segmentation method as described above.

For example, FIG. 3E illustrates a point cloud being projected onto multiple parallel projections, according to some embodiments. Point cloud 350 which includes points representing a coffee mug is projected onto parallel horizontal projections 352 that include planes orthogonal to the Z axis. Point cloud 350 is also projected onto vertical projections 354 that include planes orthogonal to the X axis, and is projected onto vertical projections 356 that include planes orthogonal to the Y axis. In some embodiments, instead of planes, multiple projections may include projections having other shapes, such as multiple cylinders or spheres.

### Generating Images Having Depth

In some embodiments, only a subset of the pixels of an image frame will be occupied and may correspond to a subset of 3D points of a point cloud. Information regarding the points (e.g., geometry, texture, and other attributes) can be encoded by generating maps corresponding to the patch images, and storing, for each occupied pixel in the map, the depth/texture/attribute value of its associated point(s) of the patch images.

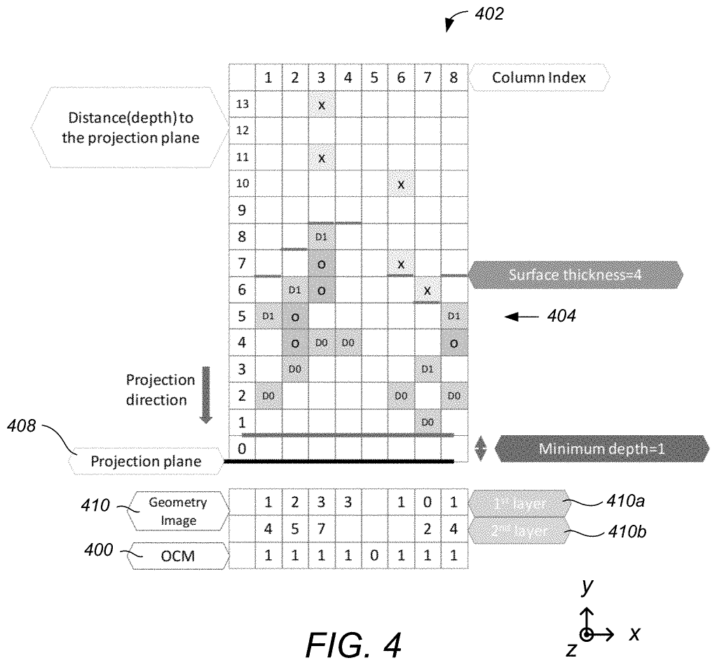

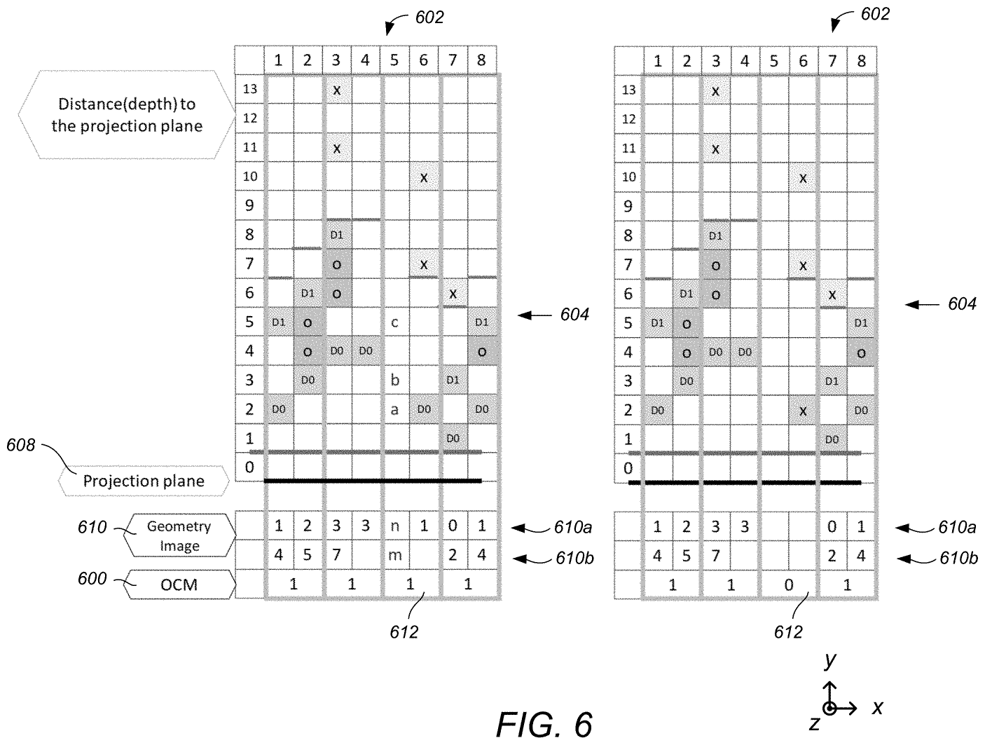

In some embodiments, spatial information may be stored with various variations, for example spatial information may:
a. Store depth as a monochrome image.
b. Store depth as Y and keep U and V empty (where YUV is a color space, also RGB color space may be used).
c. Store depth information for different patches in different color planes Y, U and V, in order to avoid inter-patch contamination during compression and/or improve compression efficiency (e.g., have correlated patches in the same color plane). Also, hardware codec capabilities may be utilized, which may spend the same encoding/decoding time independently of the content of the frame.
d. Store depth patch images on multiple images or tiles that could be encoded and decoded in parallel. One advantage is to store depth patch images with similar/close orientations or based on visibility according to the rendering camera position in the same image/tile, to enable view-dependent streaming and/or decoding.
e. Store depth as Y and store a redundant version of depth in U and V.
f. Store X, Y, Z coordinates in Y, U, and V.
g. Different bit depth (e.g., 8, 10 or 12-bit) and sampling (e.g., 420, 422, 444 . . . ) may be used. Note that different bit depth may be used for the different color planes.
h. Generate an occupancy map having one or more layers. The occupancy map can indicate, for each occupied pixel of an image frame, the depth/texture/attribute value of its associated point(s). For example, an occupancy map can indicate, for each image frame, the locations of one or more patch images packed into the image frame, and depth information of one or more sets of points corresponding to the patch images in the image frame. Further, the depth information can indicate, for each patch image, depths of the set of points corresponding to the patch image (e.g., with respect to a projection direction perpendicular to the patch plane of the patch image). Example techniques for generating occupancy maps are shown and described with respect to FIGS. 4-9 and 11.
i. Store one or more additional images (e.g., in conjunction with one or more patch images and/or occupancy maps), each containing attribute information regarding points of the point cloud (e.g., color information or other attribute information regarding occluded points). Example techniques for generating additional images containing attribute information are shown and described with respect to FIG. 6.

### Padding

In some embodiments, padding may be performed to fill the non-occupied pixels with values such that the resulting image is suited for video/image compression. For example, image frame padding module 210 or image padding module 262 may perform padding as described below.

In some embodiments, padding is applied on pixels blocks, while favoring the intra-prediction modes used by existing video codecs. More precisely, for each block of size B×B to be padded, the intra prediction modes available at the video encoder side are assessed and the one that produces the lowest prediction errors on the occupied pixels is retained. This may take advantage of the fact that video/image codecs commonly operate on pixel blocks with pre-defined sizes (e.g., 64×64, 32×32, 16×16 . . . ). In some embodiments, other padding techniques may include linear extrapolation, in-painting techniques, or other suitable techniques.

### Video Compression

In some embodiments, a video compression module, such as video compression module 212 or video compression module 264, may perform video compression as described below.

In some embodiments, a video encoder may leverage an occupancy map, which describes for each pixel of an image whether it stores information belonging to the point cloud or padded pixels (among other information). In some embodiments, such information may permit enabling various features adaptively, such as de-blocking, adaptive loop filtering (ALF), or shape adaptive offset (SAO) filtering. Also, such information may allow a rate control module to adapt and assign different, e.g., lower, quantization parameters (QPs), and in an essence a different amount of bits, to the blocks containing the occupancy map edges. Coding parameters, such as lagrangian multipliers, quantization thresholding, quantization matrices, etc. may also be adjusted according to the characteristics of the point cloud projected blocks. In some embodiments, such information may also enable rate distortion optimization (RDO) and rate control/allocation to leverage the occupancy map to consider distortions based on non-padded pixels. In a more general form, weighting of distortion may be based on the “importance” of each pixel to the point cloud geometry. Importance may be based on a variety of aspects, e.g., on proximity to other point cloud samples, directionality/orientation/position of the samples, etc. Facing forward samples, for example, may receive a higher weighting in the distortion computation than backward facing samples. Distortion may be computed using metrics such as Mean Square or Absolute Error, but different distortion metrics may also be considered, such as SSIM, VQM, VDP, Hausdorff distance, and others.

### Point Cloud Compression

As described herein, a point cloud can be represented by one or more videos each having one or more image frames, where each image frame is packed with one or more patch images, and where each occupied pixel of an image frame corresponds to one or more respective 3D points in the point cloud. Further, information regarding the points (e.g., geometry and other attributes) can be encoded by generating maps corresponding to the patch images, and storing, for each occupied pixel in the map, the depth, and other attribute value of its associated point(s) of the patch images. Each of these maps can be stored as one or more image frames in a video.

In some implementations, information regarding the points (e.g., geometry) can encoded in one or more geometry images and/or occupancy maps. In some implementations, the geometry images and/or occupancy maps can be stored as one or more image frames of one or more videos. As an example, the geometry images can be stored as one or more image frames of a first video, and an occupancy map can be stored as one or more images frames of a second video.

In some implementations, an occupancy map can indicate the presence and location of a point with respect to a projection plane (e.g., the presence of a point in a direction perpendicular to the projection plane). In some implementations, an occupancy map can indicate the presence and locations of multiple points with respect to a projection plane, including points that are occluded by other points with respect to the projection plane. For example, the occupancy map can indicate not only the presence and location of the point nearest to the projection plane in a direction perpendicular to the projection plane (e.g., the depth of the point), but also the presence and locations of one or more additional points farther from the projection plane in the direction perpendicular to the projection plane (e.g., the depth of the points occluded by the nearest point).

Further, an occupancy map can be compressed. This can be beneficial, for example, in reducing costs and time associated with storing, processing, and/or transmitting data regarding the point cloud. In some implementations, an occupancy may can down-sampled and/or encoded in a lossy manner (e.g., such that at least some of the information of the occupancy map is discarded). In some implementations, a down-sampled and/or encoded occupancy map can be subsequently reconstructed, such that least some of the discarded information is recovered).

FIG. 4 illustrates an example process of generating an occupancy map 400 and a geometry image 410 representing one or more points in a point cloud 402. In this example, a point cloud 402 includes a number of 3D points 404 (represented by shaded boxes in a grid). For ease of illustration, FIG. 4 depicts the points 404 on a single plane of the point cloud 402 (e.g., a single x-y plane). However, in practice, the point cloud 402 can include multiple points 404 on multiple different planes (e.g., multiple x-y planes stacked along the z-direction). In some implementations, the point cloud 402 can be included in and/or represent three-dimensional visual volumetric content.

As described herein, the points 404 of the point cloud 402 can be projected onto 2D planes in one or more groups, and stored as one or more 2D images (e.g., patch images). Further, multiple points 404 may end up being projected onto the same position of the planes. In the example shown in FIG. 4, the points 404 are projected in a projection direction (e.g., in the negative y direction) onto a projection plane 408. Due to the arrangement of the points 404, at least some points are occluded by other points with respect to the projection plane 408 (the bottommost point in each column of the grid occludes one or more other points above it in the column).

An occupancy map 400 and geometry image 410 can be generated to provide information regarding one or more of the points 404 in the point cloud 402. For instance, a geometry image 410 can include one or more layers, each indicating certain information regarding one or more of the points 404. Further, an occupancy map 400 can indicate additional information regarding one or more of the points 404.

As an example, the geometry image 410 can include a first layer 410a indicating the depth of the point 404 nearest to the projection plane 408 (represented by shaded boxes marked “D0”) minus the minimum depth across the columns (e.g., in this example, 1). For instance, proceeding from the left column to the right column, the values in the first layer 410a are 1, 2, 3, 3, null (as there are no points in the column), 1, 0, and 1, respectively.

As another example, the geometry image 410 can include a second layer 410b indicating the depth of additional points 404 farther from the projection plane 408. In some implementations, the second layer 400b can indicate the depth of the farthest point 404 from the projection plane 408 in a column, within a particular surface thickness t_{surface} from the nearest point 404 in the column (represented by shaded boxed marked “D1”), and minus the minimum depth across the columns. For instance, in the example shown in FIG. 4, the surface thickness t_{surface} is 4, and is indicated in each column by a thick horizontal line. Proceeding from the left column to the right column, values of the second layer 410b are 4, 5, 7, null (as there are no additional points in that column), null (as there are no points in that column), null (as there are no points within 4 of the nearest point in that column), 2, and 4, respectively. Although a surface thickness t_{surface} of 4 is shown in FIG. 4, this is merely an illustrative example. In practice, the surface thickness t_{surface} can vary, depending on the implementation. In some implementations, the surface thickness t_{surface} can be selected empirically by a user (e.g., based on the requirements for a particular application).

Further, the occupancy map 400 indicates whether at least one point has been projected onto a particular location of the projection plane 408. For instance, proceeding from the left column to the right column, this can indicated as 1 (indicating that at least one point has been projected onto the projection plane 408 with respect to that column), 1, 1, 1, 0 (indicating that no points have been projected onto the projection plane 408 with respect to that column), 1, 1, and 1, respectively.

The points 404 that are not represented by the occupancy map 400 (e.g., the points 404 (i) between the nearest point and the farthest point within a particular surface thickness from the nearest point, represented by shaded boxes marked “o,” and/or (ii) the points beyond the surface thickness from the nearest point, represented by shaped boxed marked “x”), and/or (iii) the points the encoder decides not to project can be encoded in one of more other images and/or image layers. For example, the remaining points 404 can be encoded by explicitly signal the geometry values and stored as one or more additional patch images (e.g., in one or more image frames of a video).

However, in some implementations, it may be less desirable to encode information regarding the points 404 according to explicitly signaling, due to the computational resources and/or time needed to generate, store, and/or transmit information encoded in this manner. As an alternative, information regarding at least some of the points 404 can be encoded according to alternative techniques, rather than according to explicitly signaling.

As an example, an occupancy map image can indicate, for each column, the number of points 404 that are between the point in the first layer 410a of the geometry image 410 and the point in the second layer 410b of the geometry image 410 of that column, and the depths of each of those points. In some implementations, assuming that the distance between the first layer 410a (e.g., the depths of the points nearest to the projection plane minus the minimum depth across the columns) and the second layer 410b (e.g., the depths of the points farthest from the projection plane, within a particular surface thickness of the nearest point, and minus the minimum depth across the columns) is equal to a value D, this distance D can be subdivided to K segments of equal size. Given these segments, a map value of length K bits can be generated, where each bit in this K-bit map represents whether a point is present within the corresponding Kth segment. This representation excludes the point that is represented by the second layer 400b. As an example, assuming K=8, if there are points at the first, third and fourth segments with respect to a particular position on the projection plane, then the value of the layer corresponding to that position on the projection plane can be set to 00001101 (e.g., from right to left, the first, third, and fourth bits are set to 1, and the remaining bits are set to 0). This value, plus 1 (e.g., indicating that the location is occupied) can be assigned to the corresponding pixel values of the occupancy map layer. A value of 9 can indicate an empty location.

### Full Precision Occupancy Map

In some implementations, when the spatial resolution of an occupancy map (or a sequence of occupancy maps, such as an occupancy map video having multiple image frames) is the same as the spatial resolution of a patch image (or a sequence of patch images, such as a geometry video having multiple image frames), each pixel in the occupancy map can be mapped to a corresponding pixel of the patch image (e.g., on a one-to-one basis).

In particular, when the occupancy map allocates N bits for each pixel, all the points on the same projection line (e.g., a projection line perpendicular to the projection plane), and having a distance from the first layer point smaller than or equal to N, can be represented by the occupancy map without the need to signal any additional points in a second layer (e.g., in the case the distance is integer).

In some implementations, the points corresponding to a particular pixel in the patch image can be represented by a corresponding encoded value of a pixel in the occupancy map with or without signaling the second layer of the geometry image. The encoded value can be generated by determining, for the points correspond to the pixel in the patch image, a corresponding binary value representing the depth of the points from the projection plane. The binary values can be summed together, and the sum can be used as the value of a pixel in the occupancy map. As an example, for each projected point, its corresponding pixel value in the occupancy map can be calculated using the following pseudo code:

TABLE 3
Pseudo code for determining encoded values
of a pixel in an occupancy map.

distanceCode = Σᵢ₌₁^{N-1} occluded_point[i] × (1 << (i−1));
distanceCode += (first_layer_point);

where occluded_point [i] indicates the presence of a point at a distance i from the first layer point along the same projection line, and where << is a bit shift left operation and (first_layer _point) indicates the presence of a points in the first layer. The term first_layer _point indicates that there is a point mapped to that location and its value is expected to be always equal to 1 if any of the other values are non-zero (e.g., the corresponding pixel of the patch image is not empty). In this case, the first bit can be forced to 1. Alternatively, its value can ignored and can be assume to always have a value of 1 during a decoding process.

The above implies the following cases:
If distanceCode=0, this indicates that the current pixel is empty and that there are no corresponding point cloud points at that location.
If distanceCode=1, this indicates that only a single point (i.e., the first layer point) exists.
If distanceCode>1 then additional points exist after the first point and are given the bit values distanceCode[i] with i from 1 to N−1.

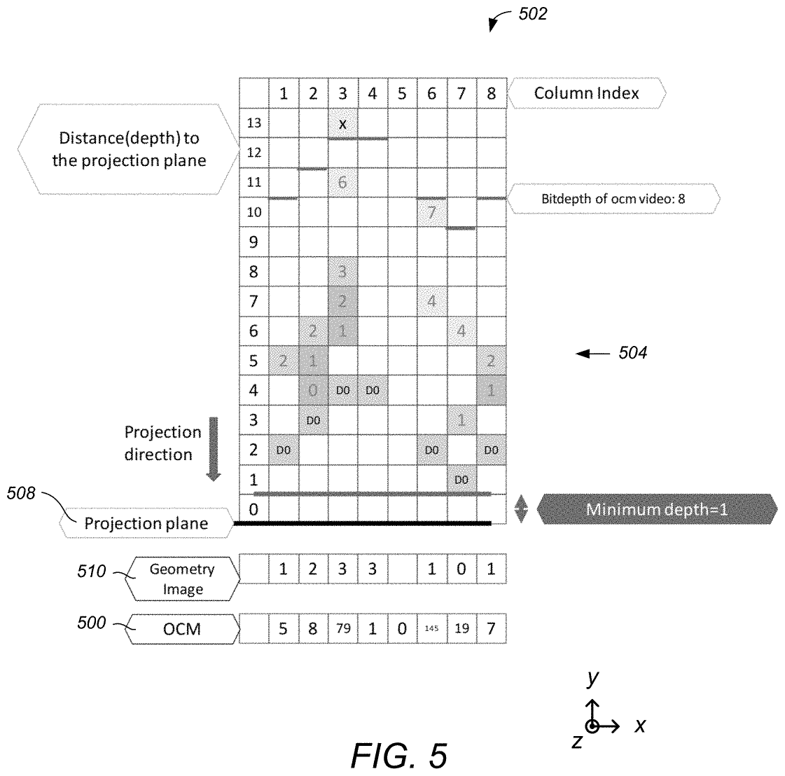

FIG. 5 illustrates an example implementation of the aforementioned process for generating an occupancy map 500. In this example, a point cloud 502 includes a number of 3D points 504 (represented by shaded boxes in a grid). For ease of illustration, FIG. 5 depicts the points 405 on a single plane of the point cloud 502 (e.g., a single x-y plane). However, in practice, the point cloud 502 can include multiple points 504 on multiple different planes (e.g., multiple x-y planes stacked along the z-direction).

As described herein, the points 504 of the point cloud 502 can be projected onto 2D planes in one or more groups, and stored as one or more 2D images (e.g., patch images). Further, multiple points 504 may end up being projected onto the same position of the planes. In the example shown in FIG. 5, the points 504 are projected in a projection direction (e.g., in the negative y direction) onto a projection plane 508. Due to the arrangement of the points 504, at least some points are occluded by other points with respect to the projection plane 508 (the bottommost point in each column of the grid occludes one or more other points above it in the column).

An occupancy map 500 and a geometry image 510 can be generated to provide information regarding one or more of the points 504 in the point cloud 502. For instance, a geometry image 510 can include one or more layers, each indicating certain information regarding one or more of the points 504. Further, an occupancy map 500 can indicate additional information regarding one or more of the points 404.

Further, the geometry image 510 can include a single layer indicating the depth of the point 504 nearest to the projection plane 508 (represented by shaded boxes marked “D0”) minus the minimum depth across the columns (e.g., in this example, 1). For instance, proceeding from the left column to the right column, the values of the geometry image are 1, 2, 3, 3, null (as there are no points in the column), 1, 0, and 1, respectively.

As another example, the occupancy map 500 can indicate the presence and position of additional points 504 farther from the projection plane 508 in each column (e.g., other than the nearest point 504 in each column). As described herein, the occupancy map 500 can indicate the depth of the additional points 504 using several encoded values, each corresponding to a particular pixel in the patch image. The encoded values can be generated by determining, for the points corresponding to the pixel in the patch image, one or more binary values representing the depth of the points from the point 504 nearest to the projection plane 508 (D0). The binary values can be summed together, and the sum can be used as the value of a pixel in the occupancy map. In some implementations, this process can performed with respect to the subset of the points that within a particular distance from the point 504 nearest to the projection plane 508 (e.g., corresponding to a bit depth of the occupancy map 500).

For example, referring to the first column from the left, points are present at depths of 1 and 4 from the projection plane 508, after subtracting the minimum depth across the columns (in this example, 1). This can be encoded as the binary expression 1+100=101 (or the decimal expression 1+4=5). The first binary term 1 represents the presence of at least one point in the column. The second binary term 100 represents the presence of a point at a depth of 3 from the nearest point in the column from the projection plane 508, and an absence of points at a depths of 2 and 3 from the nearest point. For example, the bit in the third position of the term is 1, and the remaining bits of the term are 0 (e.g., 1<<2, 0<<1, and 0<<0, where the bit shift left magnitude for each point is indicated in decimal integers in the shaded boxes).

As another example, referring to the second column from the left, points are present at depths of 2, 3, 4, and 5 from the projection plane 508 (after subtracting the minimum depth of 1). This can be encoded as the binary expression 1+111=1000 (or the decimal expression 1+7=8). The first binary term 1 represents the presence of at least one point in the column. The second binary term 111 represents the presence of points at depths of 1, 2, and 3 from the nearest point in the column from the projection plane 508 (e.g., the bits in the first, second, and third positions are 1 (1<<2, 1<<1, and 1<<0).

As another example, referring to the third column from the left, points are present at depths of 3, 5, 6, 7, 10, and 12 from the projection plane 508 (after subtracting the minimum depth of 1). The distance between the nearest point in the column and the point at the depth of 12 is 9, which is greater than the bit depth of the second layer 500b (in this example, 8). Accordingly, the point at the depth of 12 is not considered when determining the encoded value for the second layer 500b (indicated by the symbol “x”). This point can be separately encoded using a different technique or discarded.

The remaining points can be encoded as the binary expression 1+1001110=1001111 (or the decimal expression 1+78=79). The first binary term 1 represents the presence of at least one point in the column. The second binary term 1001110 represents the presence of points at depths of 2, 3, 4, and 7 from the nearest point in the column from the projection plane 508. For example, the bits in the first, second, third, and fourth positions are 1, and the remaining bits of the term are 0 (e.g., 1<<6, 0<<5, 0<<4, 1<<3, 1<<2, 1<<1, and 0<<0, where the bit shift left magnitude for each point is indicated in decimal integers in the shaded boxes).

As another example, referring to the fourth column from the left, a point is present at a depth of 3 from the projection plane 508. There are no other points in this column. Thus, the point can be encoded as the value 1 (e.g., 1+0).

As another example, referring to the fifth column from the left, there are no points in the column. Thus, this can be encoded as the value 0.

The encoded values for the remaining columns can be generated in a similar manner as described above.

Although a bit depth of 8 is shown and described with respect to, FIG. 5, this is merely an illustrative example. In practice, the bit depth can vary, depending on the implementation. As an example, in some implementations, the bit depth can be less than 8 (e.g., 7, 6, 5, etc.) or greater than 8 (e.g., 9, 10, 11, etc.). In some implementation, the threshold can be smaller than the bit depth. In some implementation, the threshold can be selected empirically by a user or by a encoder (e.g., based on the requirements for a particular application). When the threshold is smaller than the bit depth of the occupancy map image, the threshold may not need to be signaled.

In the example shown and described with respect to FIG. 5, encoded values for a particular column are generated based on a sum of two binary terms (e.g., a first binary term indicating whether any points are present in the column, and a second binary term indicating the depths of additional points in the column other than the point nearest to the projection plane). However, in some implementations, encoded values for a particular column can be generated based on a single binary term (e.g., a single binary term indicating the depths of each of the points in the column).

For example, referring to the first column from the left, points are present at depths of 1 and 4 from the projection plane 508 (after subtracting the minimum depth of 1). This can be encoded as the binary term 1001 (or the decimal term 9). The binary term 1001 represents the presence of at least one point in the column (e.g., the first bit from the right is 1) and the presence of a point at a distance of 3 from the nearest point in the column from the projection plane 508 (e.g., the fourth bit from the right is 1).

As another example, referring to the second column from the left, points are present at depths of 2, 3, 4, and 5 from the projection plane 508 (after subtracting the minimum depth of 1). This can be encoded as the binary term 1111 (or the decimal term 15). The binary term 1111 represents the presence of at least one point in the column (e.g., the first bit from the right is 1) and the presence of points at distances of 1, 2, and 3 from the nearest point in the column from the projection plane 508 (e.g., the second, third, and fourth bits from the right are each 1).

The encoded values for the remaining columns can be generated in a similar manner as described above.

In the example techniques described above (e.g., with respect to FIGS. 4 and 5), the depths of points in the point cloud are expressed in increments of 1 (e.g., depths are binned into discrete bins having a length of 1). However, this need not be in the case. In some implementations, the depths of points in the point cloud can be expressed in increments other than 1 (e.g., 0.5, 0.75, 1.25, 2, 3, or any other value) and/or according to variable increments. For example, during the occupancy map generation process, a variable N specifying the depth interval can be signaled at a certain level of the encoding process (e.g., in the sequence parameter sets, in the frame/picture parameter sets, in the tile group header, at the patch level, or at some other level). As another example, the depth interval can increase non-uniformly from the projection plane. For example, the depth interval can increment logarithmically with increasing distance from the projection plane (e.g., according to a base M). This can be beneficial, for example, as it enables a larger distance to be represented using a limited bit depth in the occupancy map.

### Explicit Value Coded Occupancy Map

In some implementation, the depth of each point can be explicitly encoded in an occupancy map. For instance, if only one occluded point per position is being signaled, the depth of that point can be explicitly encoded in the occupancy map (e.g., instead of using bit shifted terms to represent multiple different points, as described above).

In some implementation, an occupancy map is not required to reconstruct the locations of each of the points of the point cloud. Instead, the locations of the points occluded by the points nearest of the projection plane (with respect to each column) can be derived from the occupancy map directly, since they indicate fixed depth information that is not expressed relative to the corresponding values in the first layers. Furthermore, in at some implementations, this encoding process can be performed using fewer computation resources and/or time (e.g., compared to the technique shown and described with respect to FIG. 5), as it does not require performing a division process involving the distance between the points of the first layer and the second layer. For example, the values for the occupancy map can be determined according to the pseudo-code (empty?0: min(D1+1, 1<<occupancy_map _bitdepth−1)).

As an example, referring to FIG. 4, the values of the second layer 410b can be signaled without expressly using the second layer. Instead, the values of the occupancy map 400 can be set as the difference between the values of the second layer 400b and the values of the first layer 400a. Then, the value can be incremented by 1 if the position is occupied (e.g., the presence of at least one point in the column).

Accordingly, referring to FIG. 4, the values of the occupancy map 400 (from left to right) can be 4 (e.g., 4-1+1), 4 (e.g., 5-2+1), 5 (e.g., 7-3+1), 1 (as there is only a single point in the column), null (as there are no points in the column), 1 (as there is only a single point in the column), 3 (e.g., 2-0+1), 4 (e.g., 4-1+1). Accordingly, information regarding occluded points need not necessarily be expressed as the second layer 400b. In some implementations, the encoder to make a determination regarding which encoding technique is used to encode this information.

Further, in some implementations, the values in the layers (e.g., occupancy map and/or geometry image layers) can be scaled and quantized. As an example, 1 can be scaled to 32 and 2 can be scaled to 64. When the reconstructed value from the video encoder for the value is between 16 to 48, it can be set as 32. If a reconstructed value is between 49 and 81, the value will be 2. In some implementations, this may result in distortions in the encoded information (e.g., due to a non-lossless encoding of information). In some implementations, the quantization step size can be predefined or it can be signaled (e.g., as one or more parameter values during the encoding process).

In some implementations, when the third layer 400c is determined based on a difference between the vales of the first layer 400a and the second layer 400b, the difference can be calculated from the video decoded first layer 400a instead of the original first layer values.

### Down-Sampled Occupancy Map

In some implementations, an occupancy map can be down-sampled (e.g., the spatial resolution of the occupancy map can be reduced with respect to one or more dimensions). This can be beneficial, for example, in reducing the computational resources and/or time needed to generate, store, and/or transmit information encoded in the occupancy map. For example, one pixel in an occupancy map can correspond to [ratio0×ratio1] pixels in the geometry image, where ratio0 was used to scale the occupancy map in one dimension (e.g., the horizontal or x-dimension) and ratio1 was used to scale the occupancy map in another dimension (e.g., the vertical or y-dimension).

Further, the decoder can process a down-sampled occupancy map by up-sampling the occupancy map to the original, nominal resolution before extracting geometry and attribute information from the corresponding image frames of a video. In some implementations, [ratio0×ratio1] pixels in the occupancy map image can be assigned to the same value, although some of these samples could be trimmed away (e.g., given the size information that is signaled for each image patch for the vertical and horizontal dimensions). In such cases, the decoder can read the geometry and attribute values from the pixels corresponding to these non-zero occupancy map pixels and use them to reconstruct points in 3D space.

In some implementations, an encoder can down-sample an occupancy map according to different schemes. FIG. 6 illustrates two example schemes for down-sampling an occupancy map: an bitwise OR down-sampling scheme (left panel) and a bitwise AND down-sampling scheme (right panel) performed on a per column basis. In these examples, a point cloud 602 includes a number of 3D points 604 (represented by shaded boxes in a grid) having the same arrangement as the points 404 shown in FIG. 4. For ease of illustration, FIG. 6 depicts the points 604 on a single plane of the point cloud 602 (e.g., a single x-y plane). However, in practice, the point cloud 602 can include multiple points 604 on multiple different planes (e.g., multiple x-y planes stacked along the z-direction).

Referring to the left panel of FIG. 6, a geometry image 610 can be encoded with information regarding one or more of the points 604 in the point cloud 602. Further, an occupancy map 600 can indicate additional information regarding one or more of the points 604.

For instance, as described with respect to FIG. 4, a geometry image 610 can include one or more layers, each indicating certain information regarding one or more of the points 604. As an example, the geometry image 610 can include a first layer 610a indicating the depth of the point 604 nearest to the projection plane 608 minus the minimum depth across the columns (e.g., in this example, 1). As another example, the geometry image 610 can include a second layer 610b indicating the depth of additional points 604 farther from the projection plane 608 (e.g., the depth of the farthest point 604 from the projection plane 708 in a column, within a particular surface thickness t_{surface} from the nearest point 604 in the column.

Further, the occupancy map 600 can indicate whether a point is present with respect to particular locations on the projection plane 708. In this example, each element of the occupancy map represents two corresponding columns of the projected points 604 (e.g., the occupancy map is down-sampled according to a down-sampling ratio of two in the x direction).

In this example, the occupancy map 600 is down-sampled according to a bitwise OR operation on a per column basis. For instance, for each element of the occupancy map, the element can be set to a value of 1 if a point is present in either of the corresponding columns. Otherwise, the element can be set to a value of 0. As an example, referring to the fifth and sixth columns form the left, the fifth column does not contain any points, and the sixth column contains at least one point. Thus, the element 612 corresponding to those columns is set to 1. Further, according to this down-sampling scheme, the fifth column is marked as occupied in the occupancy map despite an absence of points at that position. Therefore new points need to be derived (represented by box having a “a,” “b,” and/or “c”) and their depth will be signaled in the first and/or the second layers of the geometry image.

The remaining elements of the occupancy map 600 can be set in a similar manner as described above.

In the example shown in the right panel, the occupancy map 600 can be instead down-sampled according to a bitwise AND operation on a per column basis. For instance, for each element of the occupancy map, the element can be set to a value of 1 if a point is present in both of the corresponding columns. Otherwise, the element can be set to a value of 0. As an example, referring to the fifth and sixth columns from the left, the fifth column does not contain any points, and the sixth column contains at least one point. Thus, the element 612 corresponding to those columns is set to 0. Further, according to this down-sampling scheme, the sixth column is marked as empty in the occupancy map, despite the presence of points at those positions (represented by boxes having an “x,” positioned adjacent the empty boxes in the fifth column). Therefore information regarding these points need to be separately encoded (e.g., as EOMA patches, as described in further detail below, or raw patches) or discarded.

In the example shown and described with respect to FIG. 6, down-sampling is performed according to OR operations or AND operations performed on a per column basis. However, in some implementations, when the occupancy map has non-binary values to indicate the depths of occluded points, down-sampling can performed according to bitwise OR operations or bitwise AND operations performed on a per depth basis (e.g., such that each of the points in a column, including any occluded points, are considered).

As an example, each element of a down-sampled occupancy map, the value of the element corresponding to [ratio0×ratio1] geometry pixels can be determined using a bitwise OR operation of the values of the elements in the full precision occupancy map. The pseudo code can be as follows:

TABLE 4
Example pseudo code for determining the values of the element
of a down-sampled occupancy map using a bitwise OR operation.

for(l=0; l<ratio0; l++) {

for(m=0; m<ratio1; m++){
OCMds(i,j,k) |= (OCM(ratio0*i+l, ratio1*j+m, k) − 1)
}

}
for(l=0; l<ratio0; l++) {

for(m=0; m<ratio1; m++){
OCMds(i,j,k) |= (OCM(ratio0*i+l, ratio1*j+m, k) && 1)
}

}

where OCM(i,j) is the full-precision occupancy map, k indicates the kth bit of OCM(i,j), and OCMds(i,j) indicates the down-sampled occupancy map.

As another example, instead of performing a bitwise OR operation on a per depth basis, a bitwise AND operation could be used on a per depth basis. The pseudo code can be as follows:

TABLE 5
Example pseudo code for determining the values of the element
of a down-sampled occupancy map using a bitwise AND operation.

for(l=0; l<ratio; l++) {

for(m=0; m<ratio; m++){

OCMds(i,j,k) &= (OCM(ratio0*i+l, ratio1*j+m, k) − 1)

}

}
for(l=0; l<ratio0; l++) {

for(m=0; m<ratio1; m++){
OCMds(i,j,k) |= (OCM(ratio0*i+l, ratio1*j+m, k) && 1)
}

}

In some implementations, the kth bit of an element in the down-sampled occupancy map can be set as 1 when the majority of elements in a [ratio0×ratio1] corresponding block in the occupancy map in the full-precision occupancy map have 1 on their kth bit. The pseudo code can be as follows:

TABLE 6
Example pseudo code for determining the values of the element of a
down-sampled occupancy map using a block-majority determination.

for(l=0; l<ratio; l++) {

for(m=0; m<ratio; m++){

number [k] += (OCM(ratio0*i+l, ratio1*j+m, k)==1)

}

}
If(number[k] > threshold) OCMds(i,j,k)=1

FIG. 7 illustrates two example schemes for down-sampling an occupancy map: a bitwise OR down-sampling scheme (left panel) and a bitwise AND down-sampling scheme (right panel) performed on a per depth basis. In these examples, a point cloud 702 includes a number of 3D points 704 (represented by shaded boxes in a grid) having the same arrangement as the points 404 shown in FIG. 4. For ease of illustration, FIG. 7 depicts the points 704 on a single plane of the point cloud 702 (e.g., a single x-y plane). However, in practice, the point cloud 702 can include multiple points 404 on multiple different planes (e.g., multiple x-y planes stacked along the z-direction).

Referring to the left panel of FIG. 7, a geometry image 710 can be encoded with information regarding one or more of the points 704 in the point cloud 702. Further, an occupancy map 700 can indicate additional information regarding one or more of the points 704. For instance, as described with respect to FIG. 4, an geometry image 710 can include one or more layers, each indicating certain information regarding one or more of the points 704. As an example, the geometry image 710 can include a first layer 710a indicating the depth of the point 704 nearest to the projection plane 708 minus the minimum depth across the columns (e.g., in this example, 1).

Further, the occupancy map 800 can indicate whether a point is present with respect to particular locations on the projection plane 708. In this example, each element of the occupancy map represents two corresponding columns of the projected points 704 (e.g., the occupancy map is down-sampled according to a down-sampling ratio of two in the x direction).

In this example, the occupancy map 700 is down-sampled according to a bitwise OR operation on a per depth basis, with respect to the minimum depth across the columns. For instance, for each depth from the point nearest to the projection lane in a column with respect to the minimum depth, the element values of multiple columns can be down-sampled into a single element value by performing an OR operation with respect to those values. If the element can be set to a value of 1 if a point is present at that depth in any of the corresponding columns. Otherwise, the element can be set of a value of 0.

As an example, in the first column from the left, the point 712a nearest to the projection plane 708 is positioned at a depth of 1 (after subtracting the minimum depth of 1). The first column also includes an additional point 712b positioned a distance of 3 from the nearest point 712a. Thus, the first column can be represented by the binary term 100 (or the binary term 4). Here, the binary term 100 indicates the presence of a point at a distance of 3 from the point nearest to the projection plane 708, and an absence of any other points other than the point nearest to the projection plane 708.

In the second column from the left, the point 714a nearest to the projection plane 708 is positioned at a depth of 2 (after subtracting the minimum depth of 1). The second column also includes additional points 714b-714d positioned at distances 1, 2, and 3 from the nearest point 714a, respectively. Thus, the second column can be presented by the binary term 111 (or the binary expression 7). Here, the binary term 111 indicates the presence of points at distances of 1, 2, and 3 from the point nearest to the projection plane 708.

The two columns can be down-sampled according to a bitwise OR operation. For example, a bitwise OR operation can be performed with respect to the binary term for the first column (100) and the binary term for the first column (111), resulting in the binary term 111. The resulting binary term can be incremented by 1 to indicate the presence of a point in either of the two columns (e.g., the binary expression 111+1=1000, or the decimal expression 7+1=8), and stored in the occupancy map 700 as an element 716.

Further, according to this down-sampling scheme, some of the intermediate positions between point 712a and 712b are effectively marked as occupied in the occupancy map 700, despite an absence of points at those positions (represented by boxes marked with “o”). Therefore, new points are effectively created at those positions as a result of the down-sampling process.

As another example, the sixth column from the left has points at a depths 1, 6, and 9 (after subtracting the minimum depth of 1). Thus, the sixth column can be represented by the binary term 10010000. Here, the binary term 10010000 indicates the presence of points at distances 5 and 8 from the point nearest to the projection plane 708, and an absence of any other points other than the point nearest to the projection plane 708.

The fifth column from the left is empty. Thus, the fifth column can be represented by the binary term 0.

The two columns can be down-sampled according to a bitwise OR operation. For example, a bitwise OR operation can be performed with respect to the binary term for the fifth column (0) and the binary term for the sixth column (10010000), resulting in the binary term 10010000. The resulting binary term can be incremented by 1 to indicate the presence of a point in either of the two columns (e.g., the binary expression 10010000+1=10010001, or the decimal expression 144+1=8), and stored in the occupancy map 700 as an element 716.

Further, according to this down-sampling scheme, some of the positions in the fifth column are effectively marked as occupied in the occupancy map 700, despite an absence of points at those positions (represented by boxes marked with “a,” “b,” and “c”). Therefore, new points are effectively created at those positions as a result of the down-sampling process. The nearest point (a) is at (n−1) distance from the projection plane and the second point (b) is at a distance (n−1)+5, and the third point (c) is at a distance (n−1)+8. The depth of the nearest point is signaled in the first layer of the geometry image and bitwiseOR-ed occupancy value (e.g., the binary term 10010001) is signaled in the occupancy map 700.

Elements representing the remaining columns can be generated in a similar manner as described above.

In the example shown in the right panel, the occupancy map 800 can be instead down-sampled according to a bitwise AND operation on a per depth basis with respect to the minimum depth across the columns.

As an example, as described above, in the first column from the left, the point 712a nearest to the projection plane 708 is positioned at a depth of 1 (after subtracting the minimum depth of 1). The first column also includes an additional point 712b positioned a distance of 3 from the nearest point 712a. Thus, the first column can be represented by the binary term 100 (or the binary term 4). Here, the binary term 100 indicates the presence of a point at a distance of 3 from the point nearest to the projection plane 708, and an absence of any other points other than the point nearest to the projection plane 708.

Further, as described above, in the second column from the left, the point 714a nearest to the projection plane 708 is positioned at a depth of 2 (after subtracting the minimum depth of 1). The second column also includes additional points 714b-714d positioned at distances 1, 2, and 3 from the nearest point 714a, respectively. Thus, the second column can be presented by the binary term 111 (or the binary expression 7). Here, the binary term 111 indicates the presence of points at distances of 1, 2, and 3 from the point nearest to the projection plane 708.

The two columns can be down-sampled according to a bitwise AND operation. For example, a bitwise AND operation can be performed with respect to the binary term for the first column (100) and the binary term for the first column (111), resulting in the binary term 100. The resulting binary term can be incremented by 1 to indicate the presence of a point in either of the two columns (e.g., the binary expression 100+1=101, or the decimal expression 4+1=5), and stored in the occupancy map 700 as an element 716.

Further, according to this down-sampling scheme, some of the intermediate positions between point 714a and 714d are effectively marked as empty in the occupancy map 700, despite the presence of points at those positions (represented by boxes marked with “x”). Therefore, new points are effectively deleted at those positions as a result of the down-sampling process.

As another example, as discussed above, the sixth column from the left has points at a depths 1, 6, and 9 (after subtracting the minimum depth of 1). Thus, the sixth column can be represented by the binary term 10010000. Here, the binary term 10010000 indicates the presence of points at distances 5 and 8 from the point nearest to the projection plane 708, and an absence of any other points other than the point nearest to the projection plane 708.

Further, as discussed above, the fifth column from the left is empty. Thus, the fifth column can be represented by the binary term 0.

The two columns can be down-sampled according to a bitwise AND operation. For example, a bitwise AND operation can be performed with respect to the binary term for the fifth column (0) and the binary term for the sixth column (10010000), resulting in the binary term 0. The resulting binary term can be incremented by 1 to indicate the presence of a point in either of the two columns (e.g., the binary expression 0+1=1, or the decimal expression 0+1=1), and stored in the occupancy map 700 as an element 716.

Further, according to this down-sampling scheme, some of the positions in the sixth column are effectively marked as empty in the occupancy map 700, despite an presence of points at those positions. Therefore, points are effectively removed as a result of the down-sampling process. Further, in the fifth column, a single point is effectively created (one of locations marked as a “a,” “b” or “c”) and the distance (n) is signaled in the first layer of the geometry image and bitwiseAND-ed occupancy value (1) is signalled in the occupancy map.

Elements representing the remaining columns can be generated in a similar manner as described above.

### Lossy Coded Full Precision Occupancy Map with Thresholds

In some implementations, an occupancy map can be encoded in a lossy manner (e.g., such that some of the information regarding the points is discarded). In some implementations, an occupancy map can be encoded using non-binary values. Further, element values of the occupancy map can be quantized according to different value bins.

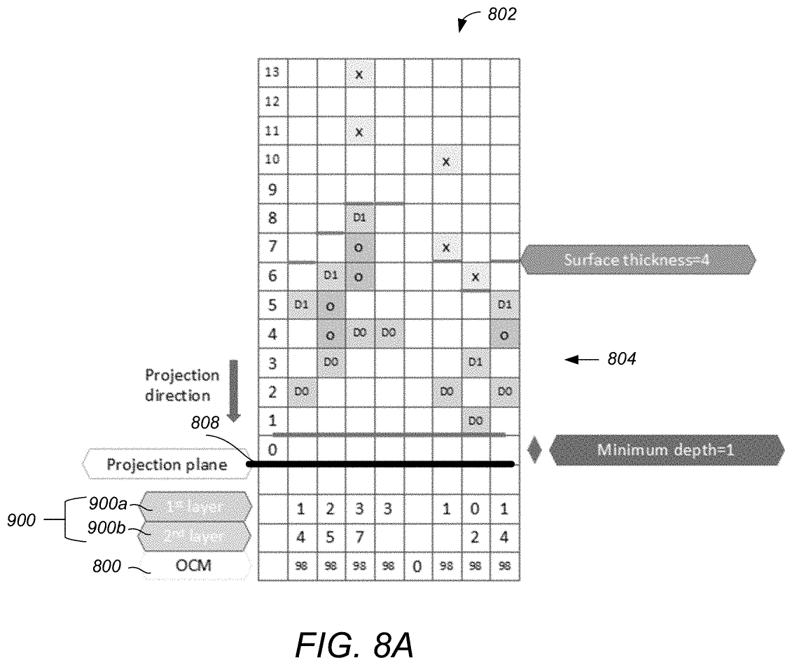

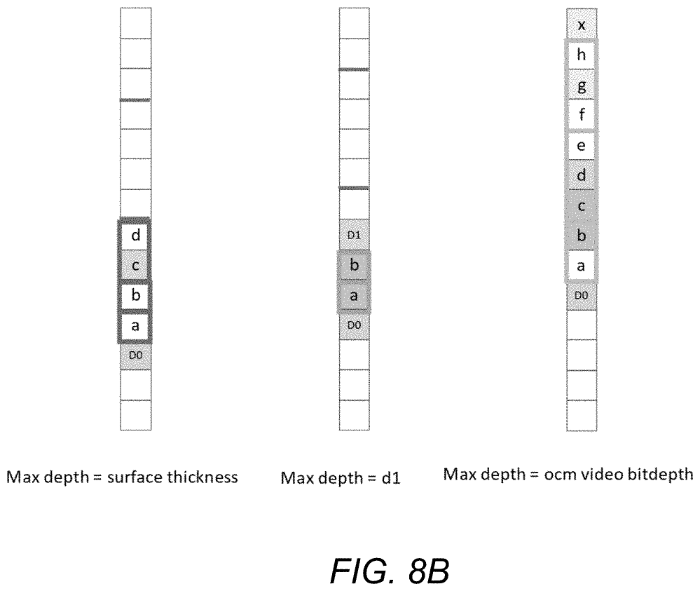

As an example, FIG. 8A shows an example scheme for a threshold-based occupancy map 800. In this example, a point cloud 802 includes a number of 3D points 804 (represented by shaded boxes in a grid) having the same arrangement as the points 404 shown in FIG. 4. For ease of illustration, FIG. 8A depicts the points 804 on a single plane of the point cloud 802 (e.g., a single x-y plane). However, in practice, the point cloud 802 can include multiple points 804 on multiple different planes (e.g., multiple x-y planes stacked along the z-direction).

An occupancy map 800 and a geometry image 810 can be encoded with information regarding one or more of the points 904 in the point cloud 902. For instance, as described with respect to FIG. 4, a geometry image 810 can include one or more layers, each indicating certain information regarding one or more of the points 804. As an example, the geometry image 810 can include a first layer 810a indicating the depth of the point 804 nearest to the projection plane 808 (after subtracting the minimum depth of 1). As another example, the geometry image 810 can include a second layer 810b indicating the depth of additional points 804 farther from the projection plane 808 (e.g., the depth of the farthest point 804 from the projection plane 808 in a column, within a particular surface thickness t_{surface} from the nearest point 804 in the column.

Further, the occupancy map 800 can indicate whether a point is present with respect to particular locations on the projection plane 808. An occupancy map value is smaller than a threshold (e.g., 196 in this example), indicates the absence of points in the column and a value over the threshold indicates the presence of one or more points in the column, and set to another fixed value (e.g., 0) to indicate the absence of points in the column. Although example fixed values are shown, these are merely illustrative examples. In practice, other fixed values also can be used, depending on the implementation.

In some implementations, each column is segmented and the presence of occluded points and the segment of the occluded points can be encoded. The size of each segment can be decided by the maximum depth of the occupancy value representation. In some implementation, the maximum depth can be same as surface thickness. In some implementation, the maximum depth can be equal to or smaller than the bitdepth of the occupancy map video. For example, referring to FIG. 8B, if the occupancy range is divided into three segments, the segments can be (a), (b) and (c, d) when the maximum limit is the surface thickness (in this example, 4). The segments can be (a) and (b) when the maximum limit is the distance between D0 and D1 (in this example, 2). The segments can be (a,b), (c,d,e) and (f,g,h) when the maximum limit is the bitdepth of the occupancy map video (in the example, 8).

As an example, when the bit depth of the occupancy map is N and the number of segments is M, the threshold step (e.g., the interval between threshold depths) is T=2^{N}/M+2′, any value between sT and (2sT−1) indicates the presence of occluded points in the segment s−2. s equals to 0 indicates the column is empty and s equals 1 indicates there is only one points at the column.

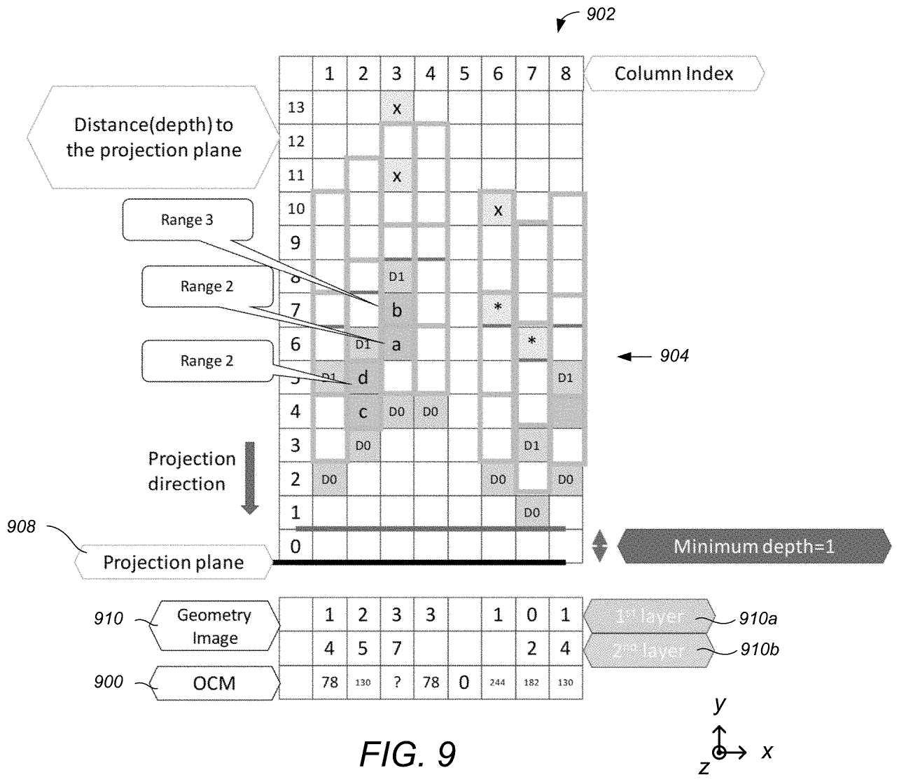

FIG. 9 shows an example scheme for generating a multi-threshold non-binary occupancy map, where M=3 and N=8, therefore T=52. In this example, a point cloud 902 includes a number of 3D points 904 (represented by shaded boxes in a grid) having the same arrangement as the points 404 shown in FIG. 4. For ease of illustration, FIG. 9 depicts the points 904 on a single plane of the point cloud 902 (e.g., a single x-y plane). However, in practice, the point cloud 902 can include multiple points 904 on multiple different planes (e.g., multiple x-y planes stacked along the z-direction).

An occupancy map 900 and a geometry image 910 can be encoded with information regarding one or more of the points 904 in the point cloud 902. For instance, as described with respect to FIG. 4, a geometry image 910 can include one or more layers, each indicating certain information regarding one or more of the points 904. Further, an occupancy map 900 can indicate additional information regarding one or more of the points 904.

As an example, the geometry image 9100 can include a first layer 9100a indicating the depth of the point 904 nearest to the projection plane 908 minus the minimum depth across the columns (e.g., in this example, 1). As another example, the geometry image 910 can include a second layer 900b indicating the depth of additional points 904 farther from the projection plane 908 (e.g., the depth of the farthest point 904 from the projection plane 908 in a column, within a particular surface thickness t_{surface} from the nearest point 904 in the column.

Further, occupancy map can indicate the presence of points (including occluded points) and the range of the depth of a single points according to a multi-threshold non-binary encoding scheme. In this example, the range is divided into a Range 0 [0 to T), a Range 1 [T to 2T−1), a Range 2 [2T to 3T−1), a Range 3 [3T to 4T−1) and a Range 4 [4T to min(5T−1, (1<<N)−1)). A value in Range 0, such as 0, indicates that the column is empty. A value in Range 1, such as 3*T/2(=78), indicates that the column is filled without any occluded points. A value in Range 2 indicates presence of occluded points in the first segment. In the case that several points are present over then several segment, the encoder can decide to signal which segment has occluded points. In this example, for the third column from the left, the encoder decides to signal Range 2 (occupancy map value=130), which has point (a). Or, the encoder can decide to signal Range 3 (occupancy map value=182), which has point (b). In some implementations, the encoder can decide to signal the farthermost range from the first layer point that has occluded points. In some implementations, the encoder can decide to signal the closest range from the first layer point nearest to the projection plane 1008 that has occluded points.

The reconstruction of the depth information from a multi-threshold non-binary occupancy map value can be performed using various techniques. In some implementations, the minimum distance in the distance range can be used to reconstruct the depth information (e.g., by reconstructing a point within the minimum distance in the distance range). In some implementations, the maximum distance in the range could be used instead (e.g., by reconstructing a point within the maximum distance in the distance range). In some implementations, the medium distance in the distance range could be used (e.g., by reconstructing a point within the medium distance in the distance range, such as between the two extremes of the range). In some implementations, the decoder can generate only one point in a particular distance range. In some implementations, the decoder can generate multiple points in a particular distance range.

For example, for the second column in FIG. 9, occupancy map value 130 is reconstructed and it is interpreted to Range 2 at the decoder, the decoder can decide to create point (c) or pint (d) or both.

In some implementations, processes such as geometry and attribute smoothing can also be performed with respect to reconstructed points. In some implementations, reconstructed points can be excluded from such smoothing operations. In some implementations, the position and the attribute values for reconstructed points can be considered during the smoothing process. In some implementations, reconstruct points can also be selectively considered depending on their positions with respect to the patch image (e.g., whether they correspond to edge positions in a patch image or are points along an interior prior of a patch image).

### Attribute Image

As described herein, a point cloud can be represented by multiple videos having one or more image frames, where each image frame is packed with one or more patch images, and where each occupied pixel of an image frame corresponds to one or more respective 3D points in the point cloud. Further, information regarding the points (e.g., geometry and attributes) can be encoded by generating maps corresponding to the patch images, and storing, for each occupied pixel in the map, the depth/attribute value of its associated point(s) of the patch images. Each of these maps can be stored as one or more image frames in a video.

In some implementations, attribute maps may only show attribute information regarding the non-occluded points of a point cloud (e.g., from the perspective of a projection plane). However, in some implementations, information regarding the occluded points of a point cloud can be stored in one or more additional patches that are included alongside of the attribute maps (e.g., in a common image frame).

### Signaling Attribute Values

In some implementations, certain attributes of occluded points (e.g., color values) can be expressly encoded (or “signaled”) as sets of additional patches that are packed into image frames alongside the regular patches, or can be implicitly derived from values in the corresponding layers. In some implementations, if signaling is used, such information could be included in a separate video stream. These additional patches may be referred to as enhanced occupancy map attribute (EOMA) patches.

In some implementations, one EOMA patch can contain points (e.g., attribute values) that correspond to occluded points from either a single corresponding patch image or from multiple such patch images. In some implementations, each image patch can have a single corresponding EOMA patch. In some implementations, each EOMA patch can indicate one or more image patches to which it corresponds (e.g., each EOMA patch can include a respective index value identifying each of its corresponding image patches).

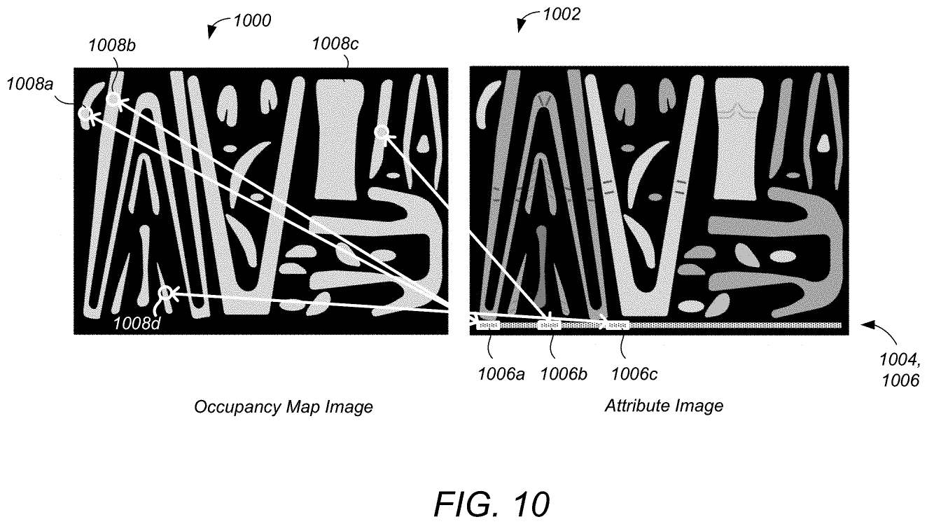

FIG. 10 shows an image frame including an example occupancy map 1000, and an image frame including a corresponding attribute map 1002. The occupancy map 1000 indicates, for each of several image patches, the presence of a point of a point cloud with respect to a projection plane of the image patch. In this example, the occupancy map 1000 shows the presence or absence of a point at each position (e.g., represented by gray or black pixels, respectively) and also the depth values of occluded points (e.g., represented by light gray). Further, the attribute map 1002 indicates, for each image patch, the texture of the non-occluded points of the point cloud (e.g., from the perspective of each respective image plane). As shown in FIG. 10, the occupancy map 1000 and the attribute map 1002 exhibit similar spatial characteristics (e.g., having a similar size and/or shape as their corresponding image patches).

In addition, the attribute map 1002 includes an EOMA region 1004 including several EOMA patches 1006. The EOMA region 1004 may be separate and distinct from the regular patches (e.g., positioned in a portion of the image frame separate and distinct from the regular patches). In some implementation, the EOMA region may be located anywhere in the image (e.g., on an edge of the image, in an interior of the image, in between one or more of the regular patches, or any other position). In contrast to the regular patches in the attribute map 1002, the EOMA patches 1006 do not have corresponding occupancy map values but their sizes are signaled through patch information bitstream.

In some implementations, a single EOMA patch can include attribute information regarding multiple different image patches. For example, the EOMA patch 1006a can include attribute information regarding the image patches 1008a and 1008b concurrently (represented by notional lines extending from the EOMA patch 1006a to the image patches 1008a and 1008b).

In some implementations, a single EOMA patch can include attribute information regarding a single image patch. For example, the EOMA patch 1006b can include attribute information regarding the image patch 1008c, and the EOMA patch 1006c can include attribute information regarding the image patch 1008d (represented by a notional line extending from the EOMA patch 1006b to the image patch 1008c, and a notional line extending from the EOMA patch 1006c to the image patch 1008d).

In some implementations, each of the EOMA patches 1006 can be sequentially ordered, and each EOMA patch 1006 can correspond to a respective one of the patch images in a sequence. For example, attribute data in the EOMA patches 1006 can be signaled in a raster scan order and according to the order that the occluded points of the patch images are extracted from the bit stream. As another example, attribute data in the EOMA patches 1006 can be signaled according to another order that is specified and fixed in the coding system (e.g., a pre-defined order, such as raster order or Morton order). As another example, attribute data in the EOMA patches can be adaptively signaled during the encoding process (e.g., an order specified by one or more parameters selected by a user).

In some implementations, each EOMA patch 1006 can indicate one or more image patches to which it corresponds. For example, each EOMA patch 1006 can include a respective index value identifying the image patch to which it corresponds. During the decoding process, a decoder can retrieve the index value specified by each EOMA patch, and apply the attributes specified by the EOMA patch to the patch image identified by the index value.

An EOMA patch 1006 can be encoded according to different data formats. As an example, an EOMA patch 1006 can include data formatted according to the following syntax:

TABLE 7
Example EOMA patch syntax.

Descriptor

eom_patch_data_unit( patchIdx ) {

| epdu_2d_shift_x[ patchIdx ] | u(v) |
|---|---|
| | u(v) |
| epdu_2d_shift_y[ patchIdx ] | se(v) |

se(v)

epdu_2d_delta_size_x[ patchIdx ]
epdu_2d_delta_size_y[ patchIdx ]

}

In this example, each EOMA patch 1006 is defined by two parameters (etpdu_2d_shift_x, etpdu_2d_shift_y) that indicate the coordinates of the start point of an the EOMA patch 1006 within the image frame of the attribute map 1002 (e.g., the x and y coordinates of the left top corner of one of the EOMA patches 1006a, 1006b, and 1006c shown in FIG. 10). Each EOMA patch 1006 is also defined by two parameters (etpdu_2d_delta_size_x, etpdu_2d_delta_size_y) defining the size of the EOMA patch 1006 within the image frame of the attribute map 1002 (e.g., the width and height of one of the EOMA patches 1006a, 1006b, and 1006c shown in FIG. 10).

In some implementations, the EOMA patches 1006 can be ordered in the image frame in the same order as the patch images to which they correspond. For example, the first EOMA patch of a sequence of EOMA patches in the image frame can include attribute information corresponding to the occluded points of a first image patch in a sequence of image patches, the second EOMA patch in the sequence of EOMA patches in the image frame can include attribute information corresponding to the occluded point of a second image patch in a sequence of image patches, and so forth. In some implementations, the order of the EOMA patches 1006 and/or their corresponding image patches can pre-defined, or can be adaptive (e.g., signaled using one or more parameter values).

In some implementations, the size of an EOMA patch 1006 can be expressed (e.g., using the parameters etpdu_2d_delta_size_x, etpdu_2d_delta_size_y) as an absolute value or as the difference between the current and a previous EOMA patch (e.g., the previous EOMA patch in the sequence of EOMA patches, or any other previous patch).

In some embodiments, an EOMA patch 1006 can signal the total number of points associated with the EOMA patch 1006. The attributes information included in the EOMA patch 1006 can be applied to the specified number of points sequentially (e.g., with respect to a particular image frame). As an example, an EOMA patch 1006 can include data formatted according to the following syntax:

TABLE 8
Example EOMA patch syntax.

enhanced_occupancy_map_attribute_patch_data_unit( patchIndex ) {

etpdu_2d_shift_x[ patchIndex ]
etpdu_2d_shift_y[ patchIndex ]
etpdu_2d_delta_size_x[ patchIndex ]
etpdu_2d_delta_size_y[ patchIndex ]
etpdu_points[ patchIndex ]

}

In this example, the number of points corresponding to the EOMA patch 1006 is defined by a single parameter (etpdupoints). The remaining parameters can be similar to those shown and described with respect to Table 7.

In some implementations, an EOMA patch 1006 can signal the number of image patches associated with the EOMA patch 1006. For example, referring to FIG. 10, the EOMA patch 1006a can signal that it is associated with two image patches (e.g., such that its attribute information is applied to each of the occluded points of those image patches), and the EOMA patches 1002b and 1002c can signal that they are associated with a single image patch (e.g., such that their attribute information is applied to each of the occluded points of their respective image patches). In some implementations, attribute values in an EOMA patch 1006 can be scanned according to a pre-defined order (e.g., raster order), or according to an adaptive order (e.g., signaled using one or more parameter values). Accordingly, the EOMA patch 1006 can include data formatted according to the following example syntax. The number of image patches associated with the EOMA patch is defined by a single parameter (etpdupatch count minus1). The remaining parameters can be similar to those shown and described with respect to Tables 7 and/or 8:

TABLE 9
Example EOMA patch syntax.

enhanced_occupancy_map_attribute_patch_data_unit( patchIndex ) {

etpdu_2d_shift_x[ patchIndex ]
etpdu_2d_shift_y[ patchIndex ]
etpdu_2d_delta_size_x[ patchIndex ]
etpdu_2d_delta_size_y[ patchIndex ]
etpdu_patch_count_minus1 [ patchIndex ]

}

In another embodiment, the number of points of image patches associated with a particular EOMA patch 1006 can be derived using the occupancy map. For example, during the decoding process, the decoder can count the number of occluded points included in each image patch. Thus, the number of occluded points in each image patch does not need to be expressly signaled.

In some implementations, only one image patch can be associated with each EOMA patch 1006. In this case, the regular patch associated with the EOMA patch is the patch with the smallest index among the possible image patches which are not associated with any EOMA patches.

In some implementations, only one image patch can be associated with each EOMA patch 1006. Further, each EOMA patch 1006 can indicate the index value of its associated image patch. As an example, an EOMA patch 1006 can include data formatted according to the following syntax:

TABLE 10
Example EOMA patch syntax.

enhanced_occupancy_map_attribute_patch_data_unit( patchIndex ) {

etpdu_reference_patch_index[ patchIndex ]
etpdu_2d_shift_x[ patchIndex ]
etpdu_2d_shift_y[ patchIndex ]
etpdu_2d_delta_size_x[ patchIndex ]
etpdu_2d_delta_size_y[ patchIndex ]

}

In this example, the image patch corresponding to the EOMA patch is expressly indicated by its index value (etpdu_reference_patch_index). The remaining parameters can be similar to those shown and described with respect to Tables 7, 8, and/or 9.

In some implementations, an EOMA patch 1006 can indicate the index values of their associated images patches. In this embodiment, multiple image patches can be associated with one EOMA patch. As an example, an EOMA patch 1006 can include data formatted according to the following syntax:

TABLE 11
Example EOMA patch syntax.

enhanced_occupancy_map_attribute_patch_data_unit( patchIndex ) {

etpdu_2d_shift_x[ patchIndex ]
etpdu_2d_shift_y[ patchIndex ]
etpdu_2d_delta_size_x[ patchIndex ]
etpdu_2d_delta_size_y[ patchIndex ]
etpdu_patch_count_minus1[ patchIndex ]
for( p = 0; p <= etpdu_patch_count_minus1; p++ ) {

etpdu_reference_patch_index[ patchIndex ][ p ]

}

}

In this example, the image patches corresponding to the EOMA patch are expressly indicated by their index value (etpdu_reference_patch_index). The remaining parameters can be similar to those shown and described with respect to Tables 7, 8, 9, and/or 10.

In some implementations, etpdu_patch_count_minus1 can be signaled using an unsigned or signed exponential Golomb code representation.

In some implementation, the position of the last raw point of the patch can be signaled, and etpdu_patch_count_minus1 can be derived based on the size of the patch. The position of the last raw point of the patch can be signaled as the (x,y) position of the block to which it belongs and the (x,y) position of the point in the block in the image. For example, the block position and the point position can be derived as following, where etpdu_patch_count indicates the number of raw points in the patch, (etpdu_2d_size_x, etpdu_2d_size_y) indicates the size of the patch and occupancy_block _size indicates the size of occupancy packing size:

TABLE 12
Example derivation of block positon and point position.

lastPosX = etpdu_patch_count %( occupancy_block_size *
etpdu_2d_size_x)
lastPosY = etpdu_patch_count /( occupancy_block_size *
etpdu_2d_size_y)
lastBlockX = lastPosX/occupancy_block_size;
lastBlockY = lastPosY/ occupancy_block_size;
lastPointX = lastPosX−lastBlockX*occupancy_block_size;
lastPointY = lastPosY−lastBlockY*occupancy_block_size;

In some implementations, posBlockX, posBlockY, posPointX and posPointY can be signaled using fixed length coding based on the size of the raw patch and the occupancy block size.

### Deriving Attribute Values

In some implementations, attribute information regarding at least some of the occluded points in a point cloud (e.g., with respect to a projection plane) can be derived instead of being explicitly signaled. For example, instead of expressly specifying the attributes of occluded points using an EOMA patches, attributes of occluded points can be presumed to be the same as those of the non-occluded points (e.g., the series of points nearest to the projection plane in each column). Occluded points that have attributes differing from those of the points nearest to the projection plane in each column can be expressly signaled (e.g., as EOMA patches or raw patches).

In some implementations, attribute information regarding at least some of the occluded points can be interpolated or extrapolated based on the attributes of their neighboring points. In some implementations, an encoder can selectively interpolate or extrapolate attribute values for a point if such interpolation or extrapolation approximates the attributes of the point sufficiently accurately (e.g., by determining a similarity or dissimilarity between the interpolated/extrapolated attributes of a point and the actual attributes of a point, and applying the interpolated or extrapolated attribute if it is sufficiently similar).

### Example Use Cases

As described herein, various techniques can be used to process and store information regarding three-dimensional visual volumetric content, such as visual volumetric content that includes one or more point clouds. However, some or all of these techniques also can be used to process and store other types of information regarding three-dimensional video content. For example, some or all of the techniques described herein can be used to process and store information regarding other types of visual volumetric video coding, such as information pertaining to point-cloud compression (e.g., Video Point Cloud Coding [V-PCC]), rendering according to three-or-more-degrees of freedom (3DoF+) (e.g., metadata for immersive video [MIV]), and mesh compression (e.g., compression for video mesh [V-Mesh]).

### Example Processes

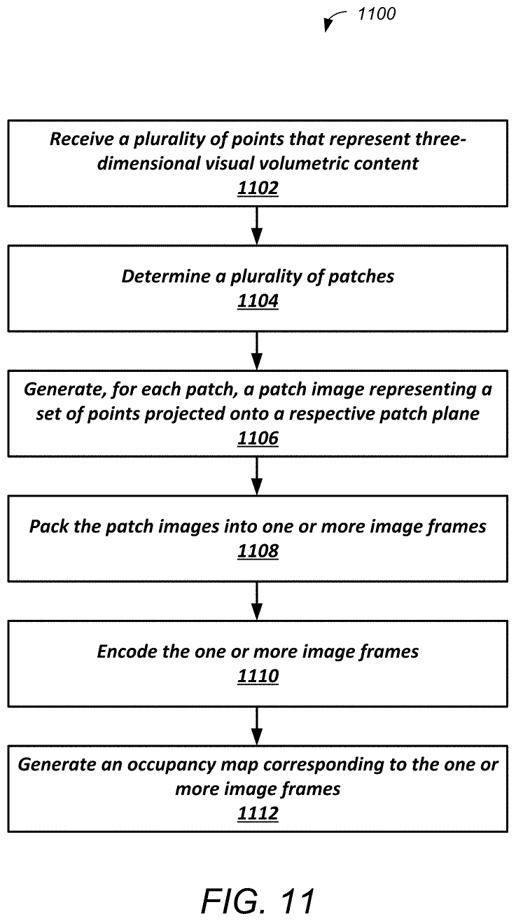

An example process 1100 for generating information regarding a point cloud is shown in FIG. 11. In some implementations, the process 1100 can be performed by one or more of the devices or systems described herein.

According to the process 1100, a system receives a plurality of points that represent three-dimensional visual volumetric content (step 1102). In some implementations, the plurality of points can be based on information received from a sensor (e.g., three-dimensional sensor data) and/or information generated by a graphics generation component. In some implementations, the three-dimensional visual volumetric content can include one or more three-dimensional point clouds.

The system determines, for the three-dimensional visual volumetric content, a plurality of patches (step 1104). Each patch corresponds to a respective portion of the three-dimensional visual volumetric content. The system generates, for each patch, a patch image representing a set of points corresponding to the patch projected onto a respective patch plane (step 1106). The system packs the patch images into one or more image frames (step 1108). Example techniques for determining patches, generating patch images, and packing patch images are described, for example, with respect to FIGS. 3A-3E.

The system encodes the one or more image frames (step 1110). In some implementations, the one or more image frames can be encoded in accordance with the high efficiency video coding (HEVC) standard or some other video coding standard or specification (e.g., VP9, VP10, or some other standard or specification).

The system generates an occupancy map corresponding to the one or more image frames (step 1112). The occupancy map indicates, for each image frame, locations of one or more of the patch images in the image frame, and depth information of one or more sets of points corresponding to the one or more of the patch images in the image frame. The depth information indicates, for each patch image, depths of the set of points corresponding to the patch image in a direction perpendicular to a patch plane of the patch image. Example techniques for generating occupancy maps are described, for example, with respect to FIGS. 4-9.

In some implementations, the occupancy map includes, for each patch image, a respective plurality of first elements. Each first element can correspond to a respective point on the patch plane of the patch image. Further, each first element can indicate respective depths of the points of the set of points corresponding to the patch image along a respective projection line, the projection line extending from the respective point on the patch plane in the direction perpendicular to the patch plane.

In some implementations, each first element can be determined based on a determination whether the set of points corresponding to the patch image includes any points along the respective projection line. In some implementations, each first element can be determined based on the depth of each point of the set of points corresponding to the patch image along the respective projection line.

In some implementations, each first element can include a respective encoded value indicating the depth of each point of the set of points corresponding to the patch image along the respective projection line. In some implementations, the encoded value can be determined based on a binary representation of the depth values of at least some of the points of the set of points corresponding to the patch image along the respective projection line. Example binary encoding techniques are described, for example, with respect to FIGS. 4-9.

In some implementations, the system can down-sample a spatial resolution of the occupancy map relative to a spatial resolution of the one or more image frames. Down-sampling the spatial resolution of the occupancy map can include determining a plurality of second elements based on the first elements, where each second element represents two or more respective first elements. Example down-sampling techniques are described, for example with respect to FIGS. 6-8.

Determining each second element can include identifying two or more respective first elements, and comparing, with respect to the two or more respective first elements, the depths of the points of the set of points corresponding to the patch image along the respective projection lines, and determining the second element based on the comparison. In some implementations, the comparison can include a bitwise binary operation. For example, the bitwise binary operation can include a bitwise OR operation or a bitwise AND operation.

In some implementations, each image frame can include a respective attribute image portion. The attribute image portion can be separated spatially from the patch images in the image frame. The attribute image portion can indicate additional attribute information regarding at least one of the patch images in the image frame. Example attribute image portions (e.g., a EOMA patches) are described with respect to FIG. 10.

In some implementations, the attribute image portion can include a plurality of attribute image sub-portions, each attribute image sub-portion indicating respective additional attribute information regarding a respective patch image in the image frame. In some implementations, each of the attribute image sub-portions can be equal in size spatially.

In some implementations, each attribute image sub-portion can include an indication of a location of the attribute image sub-portion in the image frame, and a spatial size of the attribute image sub-portion. In some implementations, each attribute image sub-portion can include an indication of a patch image in the image frame corresponding to the attribute image sub-portion. In some implementations, each attribute image sub-portion can include an indication of multiple patch images in the image frame corresponding to the attribute image sub-portion. In some implementations, each point can include spatial information regarding the point and attribute information regarding the point.

### Example Applications Using Point Cloud Encoders and Decoders

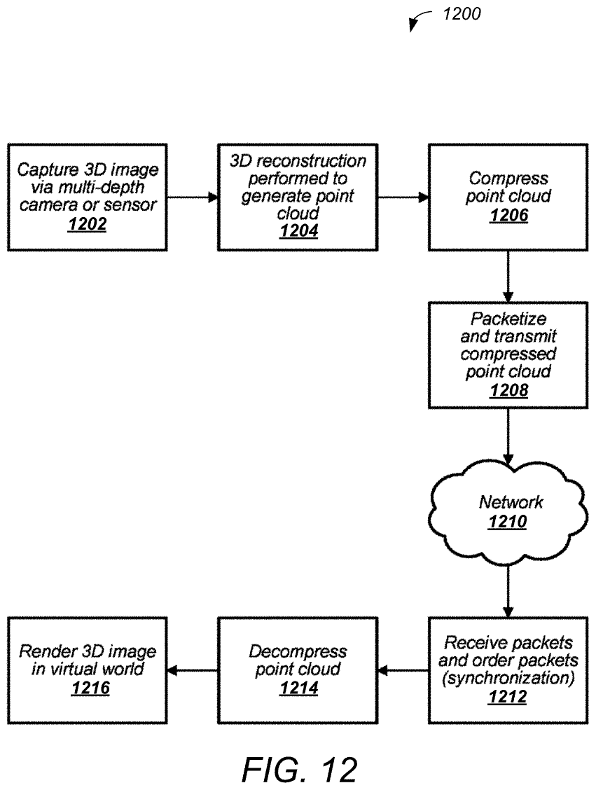

FIG. 12 illustrates an example process 1200 for utilizing compressed point clouds being in a 3-D telepresence application.

In some embodiments, a sensor, such as sensor 102, an encoder, such as encoder 104 or any of the other encoders described herein, and a decoder, such as decoder 116 or any of the decoders described herein, may be used to communicate point clouds in a 3-D telepresence application. For example, a sensor, such as sensor 102, at step 1202 may capture a 3D image and at step 1204, the sensor or a processor associated with the sensor may perform a 3D reconstruction based on sensed data to generate a point cloud.

At step 1206, an encoder such as encoder 104 may compress the point cloud and at step 1208, the encoder or a post processor may packetize and transmit the compressed point cloud, via a network 1210. At 1212, the packets may be received at a destination location that includes a decoder, such as decoder 116. The decoder may decompress the point cloud at 1214 and the decompressed point cloud may be rendered at step 1216. In some embodiments a 3-D telepresence application may transmit point cloud data in real time such that a display at 1216 represents images being observed at step 1202. For example, a camera in a canyon may allow a remote user to experience walking through a virtual canyon at 1216.

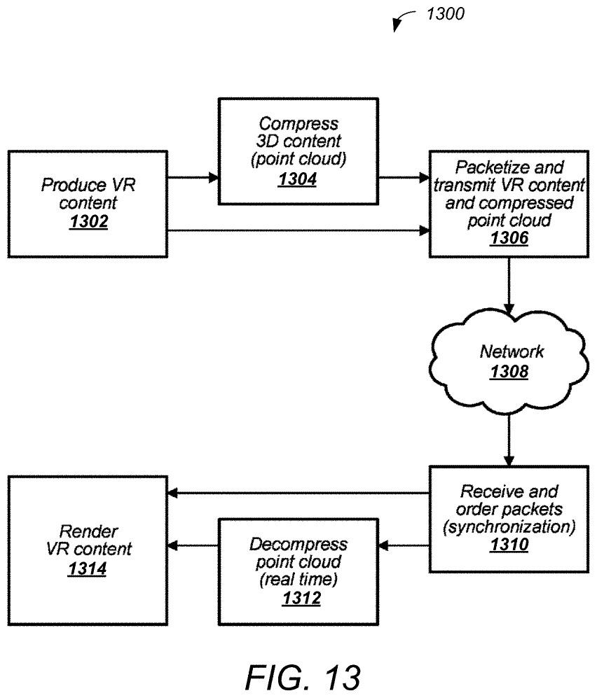

FIG. 13 illustrates an example process 1300 for using compressed point clouds in a virtual reality (VR) or augmented reality (AR) application.

In some embodiments, point clouds may be generated in software (for example as opposed to being captured by a sensor). For example, at step 1302, virtual reality or augmented reality content is produced. The virtual reality or augmented reality content may include point cloud data and non-point cloud data. For example, a non-point cloud character may traverse a landscape represented by point clouds, as one example. At step 1304, the point cloud data may be compressed and at step 1306, the compressed point cloud data and non-point cloud data may be packetized and transmitted via a network 1308. For example, the virtual reality or augmented reality content produced at step 1302 may be produced at a remote server and communicated to a VR or AR content consumer via network 1308. At step 1310, the packets may be received and synchronized at the VR or AR consumer's device. A decoder operating at the VR or AR consumer's device may decompress the compressed point cloud at step 1312, and the point cloud and non-point cloud data may be rendered in real time, for example in a head mounted display of the VR or AR consumer's device. In some embodiments, point cloud data may be generated, compressed, decompressed, and rendered responsive to the VR or AR consumer manipulating the head mounted display to look in different directions.

In some embodiments, point cloud compression as described herein may be used in various other applications, such as geographic information systems, sports replay broadcasting, museum displays, autonomous navigation, etc.

### Example Computer System

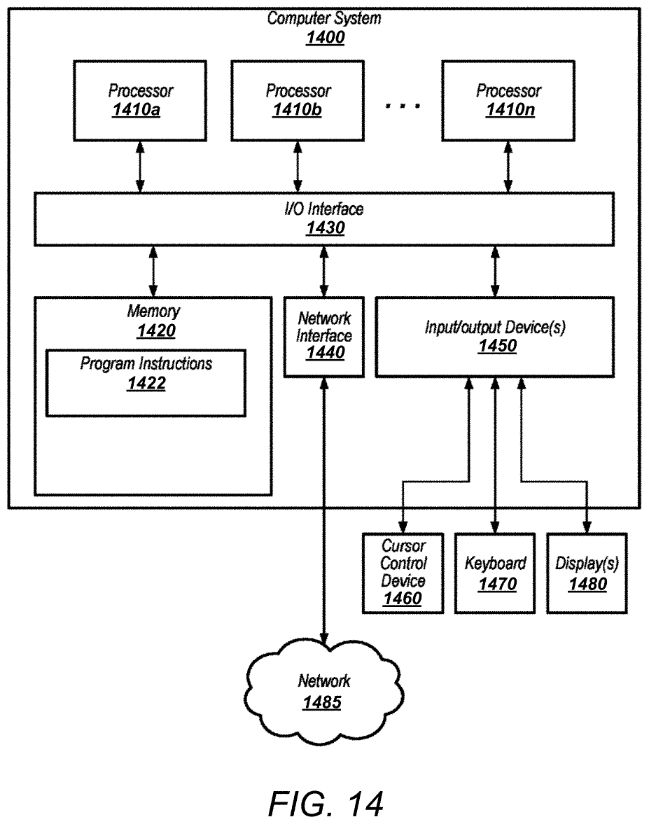

FIG. 14 illustrates an example computer system 1400 that may implement an encoder or decoder or any other ones of the components described herein, (e.g., any of the components described above with reference to FIGS. 1-13), in accordance with some embodiments. The computer system 1400 may be configured to execute any or all of the embodiments described above. In different embodiments, computer system 1400 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, a consumer device, video game console, handheld video game device, application server, storage device, a television, a video recording device, a peripheral device such as a switch, modem, router, or in general any type of computing or electronic device.

Various embodiments of a point cloud encoder or decoder, as described herein may be executed in one or more computer systems 1400, which may interact with various other devices. Note that any component, action, or functionality described above with respect to FIGS. 1-13 may be implemented on one or more computers configured as computer system 1400 of FIG. 14, according to various embodiments. In the illustrated embodiment, computer system 1400 includes one or more processors 1410 coupled to a system memory 1420 via an input/output (I/O) interface 1430. Computer system 1400 further includes a network interface 1440 coupled to I/O interface 1430, and one or more input/output devices 1450, such as cursor control device 1460, keyboard 1470, and display(s) 1480. In some cases, it is contemplated that embodiments may be implemented using a single instance of computer system 1400, while in other embodiments multiple such systems, or multiple nodes making up computer system 1400, may be configured to host different portions or instances of embodiments. For example, in one embodiment some elements may be implemented via one or more nodes of computer system 1400 that are distinct from those nodes implementing other elements.

In various embodiments, computer system 1400 may be a uniprocessor system including one processor 1410, or a multiprocessor system including several processors 1410 (e.g., two, four, eight, or another suitable number). Processors 1410 may be any suitable processor capable of executing instructions. For example, in various embodiments processors 1410 may be general-purpose or embedded processors implementing any of a variety of instruction set architectures (ISAs), such as the x86, PowerPC, SPARC, or MIPS ISAs, or any other suitable ISA. In multiprocessor systems, each of processors 1410 may commonly, but not necessarily, implement the same ISA.

System memory 1420 may be configured to store point cloud compression or point cloud decompression program instructions 1422 and/or sensor data accessible by processor 1410. In various embodiments, system memory 1420 may be implemented using any suitable memory technology, such as static random access memory (SRAM), synchronous dynamic RAM (SDRAM), nonvolatile/Flash-type memory, or any other type of memory. In the illustrated embodiment, program instructions 1422 may be configured to implement an image sensor control application incorporating any of the functionality described above. In some embodiments, program instructions and/or data may be received, sent or stored upon different types of computer-accessible media or on similar media separate from system memory 1420 or computer system 1400. While computer system 1400 is described as implementing the functionality of functional blocks of previous Figures, any of the functionality described herein may be implemented via such a computer system.

In one embodiment, I/O interface 1430 may be configured to coordinate I/O traffic between processor 1410, system memory 1420, and any peripheral devices in the device, including network interface 1440 or other peripheral interfaces, such as input/output devices 1450. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. Also, in some embodiments some or all of the functionality of I/O interface 1430, such as an interface to system memory 1420, may be incorporated directly into processor 1410.

Network interface 1440 may be configured to allow data to be exchanged between computer system 1400 and other devices attached to a network 1485 (e.g., carrier or agent devices) or between nodes of computer system 1400. Network 1485 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1450 may, in some embodiments, include one or more display terminals, keyboards, keypads, touchpads, scanning devices, voice or optical recognition devices, or any other devices suitable for entering or accessing data by one or more computer systems 1400. Multiple input/output devices 1450 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1440.

As shown in FIG. 14, memory 1420 may include program instructions 1422, which may be processor-executable to implement any element or action described above. In one embodiment, the program instructions may implement the methods described above. In other embodiments, different elements and data may be included. Note that data may include any data or information described above.

Those skilled in the art will appreciate that computer system 1400 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device comprising:
one or more processors; and
memory storing instructions that when executed by the one or more processors, cause the one or more processors to perform operations comprising:
receiving a plurality of points that represent three-dimensional visual volumetric content;
determining, for the three-dimensional visual volumetric content, a plurality of patches, wherein each patch corresponds to a respective portion of the three-dimensional visual volumetric content;
generating, for each patch, a patch image representing a set of points corresponding to the patch projected onto a respective patch plane;
packing the patch images into one or more image frames;
encoding the one or more image frames; and
generating an occupancy map corresponding to the one or more image frames, wherein the occupancy map indicates, for each image frame:
locations of one or more of the patch images in the image frame, and
depth information of one or more sets of points corresponding to the one or more of the patch images in the image frame,
wherein the depth information indicates, for each patch image, depths of the set of points corresponding to the patch image in a direction perpendicular to a patch plane of the patch image.

2. The device of claim 1, wherein the occupancy map comprises, for each patch image, a respective plurality of first elements,
wherein each first element corresponds to a respective point on the patch plane of the patch image, and
wherein each first element indicates respective depths of the points of the set of points corresponding to the patch image along a respective projection line, the projection line extending from the respective point on the patch plane in the direction perpendicular to the patch plane.

3. The device of claim 2, wherein each first element is determined based on a determination whether the set of points corresponding to the patch image comprises any points along the respective projection line.

4. The device of claim 2, wherein each first element is determined based on the depth of each point of the set of points corresponding to the patch image along the respective projection line.

5. The device of claim 2, wherein each first element comprises a respective encoded value indicating the depth of each point of the set of points corresponding to the patch image along the respective projection line.

6. The device of claim 5, wherein the encoded value is determined based on a binary representation of the depths of at least some of the points of the set of points corresponding to the patch image along the respective projection line.

7. The device of claim 2, the operations further comprising down-sampling a spatial resolution of the occupancy map relative to a spatial resolution of the one or more image frames.

8. The device of claim 7, wherein down-sampling the spatial resolution of the occupancy map comprises:
determining a plurality of second elements based on the first elements, wherein each second element represents two or more respective first elements.

9. The device of claim 8, wherein determining each second element comprises:
identifying two or more respective first elements;
comparing, with respect to the two or more respective first elements, the depths of the points of the set of points corresponding to the patch image along the respective projection lines, and
determining the second element based on the comparison.

10. The device of claim 8, wherein the comparison comprises a bitwise binary operation.

11. The device of claim 8, wherein the bitwise binary operation comprises a bitwise OR operation or a bitwise AND operation.

12. The device of claim 1, wherein each image frame comprises a respective attribute image portion,
wherein the attribute image portion is separated spatially from the patch images in the image frame, and
wherein the attribute image portion indicates additional attribute information regarding at least one of the patch images in the image frame.

13. The device of claim 12, wherein the attribute image portion comprises a plurality of attribute image sub-portions, each attribute image sub-portion indicating respective additional attribute information regarding a respective patch image in the image frame.

14. The device of claim 12, wherein each of the attribute image sub-portions are equal in size spatially.

15. The device of claim 12, wherein each attribute image sub-portion comprises:
an indication of a location of the attribute image sub-portion in the image frame, and
a spatial size of the attribute image sub-portion.

16. The device of claim 15, wherein each attribute image sub-portion comprises:
an indication of a patch image in the image frame corresponding to the attribute image sub-portion.

17. The device of claim 15, wherein each attribute image sub-portion comprises:
an indication of multiple patch images in the image frame corresponding to the attribute image sub-portion.

18. The device of claim 1, wherein the one or more image frames are encoded in accordance with the high efficiency video coding (HEVC) standard.

19. The device of claim 1, wherein each point comprises spatial information regarding the point and attribute information regarding the point.

20. A method comprising:
receiving a plurality of points that represent three-dimensional visual volumetric content;
determining, for the three-dimensional visual volumetric content, a plurality of patches, wherein each patch corresponds to a respective portion of the three-dimensional visual volumetric content;
generating, for each patch, a patch image representing a set of points corresponding to the patch projected onto a respective patch plane;
packing the patch images into one or more image frames;
encoding the one or more image frames; and
generating an occupancy map corresponding to the one or more image frames, wherein the occupancy map indicates, for each image frame:
locations of one or more of the patch images in the image frame, and
depth information of one or more sets of points corresponding to the one or more of the patch images in the image frame,
wherein the depth information indicates, for each patch image, depths of the set of points corresponding to the patch image in a direction perpendicular to a patch plane of the patch image.

21. A non-transitory, computer-readable storage medium having instructions stored thereon, that when executed by one or more processors, cause the one or more processors to perform operations comprising:
receiving a plurality of points that represent three-dimensional visual volumetric content;
determining, for the three-dimensional visual volumetric content, a plurality of patches, wherein each patch corresponds to a respective portion of the three-dimensional visual volumetric content;
generating, for each patch, a patch image representing a set of points corresponding to the patch projected onto a respective patch plane;
packing the patch images into one or more image frames;
encoding the one or more image frames; and
generating an occupancy map corresponding to the one or more image frames, wherein the occupancy map indicates, for each image frame:
locations of one or more of the patch images in the image frame, and
depth information of one or more sets of points corresponding to the one or more of the patch images in the image frame,
wherein the depth information indicates, for each patch image, depths of the set of points corresponding to the patch image in a direction perpendicular to a patch plane of the patch image.
